(19) United States
(12) Patent Application Publication
(10) Pub. No.: US 2024/0129906 A1
(43) Pub. Date: Apr. 18, 2024

(54) Trigger Frame for Low Latency Uplink Transmission

(71) Applicant: Ofinno, LLC, Reston, VA (US)

(72) Inventors: Kazi Mohammed Saidul Huq, Herndon, VA (US); Jeongki Kim, Fairfax, VA (US); Esmael Hejazi Dinan, McLean, VA (US); Leonardo Alisasis Lanante, Reston, VA (US); Tuncer Baykas, Reston, VA (US)

(73) Assignee: Ofinno, LLC, Reston, VA (US)

(21) Appl. No.: 18/378,798

(22) Filed: Oct. 11, 2023

Related U.S. Application Data
(60) Provisional application No. 63/416,038, filed on Oct. 14, 2022.

(51) Int. Cl. H04W 72/0446; H04L 5/00

(52) U.S. Cl. CPC H04W 72/0446; H04L 5/0053

(57) ABSTRACT

An access point (AP) transmits a trigger frame soliciting one or more trigger-based (TB) physical protocol data unit (PPDU) from a station (STA), the trigger frame comprising: a first indication associated with a first uplink resource allocation for the STA; a second indication associated with a second uplink resource for the STA; and a third indication indicating whether an aggregated acknowledgement mode is enabled. Based on the aggregated acknowledgement mode being enabled and on condition of receiving, from the STA, in response to the trigger frame, a first TB PPDU via the first uplink resource allocation and a second TB PPDU via the second uplink resource allocation, the AP transmits a BlockAck (BA) frame to the STA.

### CROSS-REFERENCE TO RELATED APPLICATIONS

This application claims the benefit of U.S. Provisional Application No. 63/416,038, filed Oct. 14, 2022, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates example wireless communication networks in which embodiments of the present disclosure may be implemented.

FIG. 2 is a block diagram illustrating example implementations of a station (STA) and an access point (AP).

FIG. 3 illustrates an example of a Medium Access Control (MAC) frame format.

FIG. 4 illustrates an example of a Quality of Service (QoS) null frame indicating buffer status information.

FIG. 5 illustrates an example format of a physical layer (PHY) protocol data unit (PPDU).

FIG. 6 illustrates an example that includes buffer status reporting by STAs, scheduling by an AP of uplink multi-user (MU) transmissions, and transmission of scheduled uplink transmissions by the STAs.

FIG. 7 illustrates an example of a trigger frame format.

FIG. 8 illustrates an example of uplink transmission in response to a trigger frame.

FIG. 9 illustrates an example of uplink transmission in response to a trigger frame according to an embodiment.

FIG. 10 illustrates an example of a User Info field according to an embodiment.

FIG. 11 illustrates an example of a User Info field according to an embodiment.

FIG. 12 illustrates an example of uplink transmission in response to a trigger frame according to an embodiment.

FIG. 13 illustrates an example of uplink transmission in response to a trigger frame according to an embodiment.

FIG. 14 illustrates an example of uplink transmission in response to a trigger frame according to an embodiment.

FIG. 15 illustrates an example of uplink transmission in response to a trigger frame according to an embodiment.

FIG. 16 illustrates an example of uplink transmission in response to a trigger frame according to an embodiment.

FIG. 17 illustrates an example of uplink transmission in response to a trigger frame according to an embodiment.

FIG. 18 illustrates an example process according to an embodiment.

FIG. 19 illustrates an example process according to an embodiment.

FIG. 20 illustrates an example process according to an embodiment.

FIG. 21 illustrates an example process according to an embodiment.

FIG. 22 illustrates an example process according to an embodiment.

FIG. 23 illustrates an example process according to an embodiment.

FIG. 24 illustrates an example of an uplink transmission according to an embodiment.

FIG. 25 illustrates an example of an uplink transmission according to an embodiment.

FIG. 26 illustrates an encoding of a trigger type subfield of a trigger frame in accordance with the IEEE 802.11 ax/be standard amendments.

FIG. 27 illustrates an example trigger frame which may be used in embodiments.

FIG. 28 illustrates a trigger type subfield encoding according to an embodiment.

FIG. 29 illustrates an example process according to an embodiment.

FIG. 30 illustrates an example process according to an embodiment.

### DETAILED DESCRIPTION

In the present disclosure, various embodiments are presented as examples of how the disclosed techniques may be implemented and/or how the disclosed techniques may be practiced in environments and scenarios. It will be apparent to persons skilled in the relevant art that various changes in form and detail can be made therein without departing from the scope. After reading the description, it will be apparent to one skilled in the relevant art how to implement alternative embodiments. The present embodiments may not be limited by any of the described exemplary embodiments. The embodiments of the present disclosure will be described with reference to the accompanying drawings. Limitations, features, and/or elements from the disclosed example embodiments may be combined to create further embodiments within the scope of the disclosure. Any figures which highlight the functionality and advantages, are presented for example purposes only. The disclosed architecture is sufficiently flexible and configurable, such that it may be utilized in ways other than that shown. For example, the actions listed in any flowchart may be re-ordered or only optionally used in some embodiments.

Embodiments may be configured to operate as needed. The disclosed mechanism may be performed when certain criteria are met, for example, in a station, an access point, a radio environment, a network, a combination of the above, and/or the like. Example criteria may be based, at least in part, on for example, wireless device or network node configurations, traffic load, initial system set up, packet sizes, traffic characteristics, a combination of the above, and/or the like. When the one or more criteria are met, various example embodiments may be applied. Therefore, it may be possible to implement example embodiments that selectively implement disclosed protocols.

In this disclosure, “a” and “an” and similar phrases are to be interpreted as “at least one” and “one or more.” Similarly, any term that ends with the suffix “(s)” is to be interpreted as “at least one” and “one or more.” In this disclosure, the term “may” is to be interpreted as “may, for example.” In other words, the term “may” is indicative that the phrase following the term “may” is an example of one of a multitude of suitable possibilities that may, or may not, be employed by one or more of the various embodiments. The terms “comprises” and “consists of”, as used herein, enumerate one or more components of the element being described. The term “comprises” is interchangeable with “includes” and does not exclude unenumerated components from being included in the element being described. By contrast, “consists of” provides a complete enumeration of the one or more components of the element being described. The term “based on”, as used herein, may be interpreted as “based at least in part on” rather than, for example, “based solely on”. The term “and/or” as used herein represents any possible combination of enumerated elements. For example, “A, B, and/or C” may represent A; B; C; A and B; A and C; B and C; or A, B, and C.

If A and B are sets and every element of A is an element of B, A is called a subset of B. In this specification, only non-empty sets and subsets are considered. For example, possible subsets of B={STA1, STA2} are: {STA1}, {STA2}, and {STA1, STA2}. The phrase “based on” (or equally “based at least on”) is indicative that the phrase following the term “based on” is an example of one of a multitude of suitable possibilities that may, or may not, be employed to one or more of the various embodiments. The phrase “in response to” (or equally “in response at least to”) is indicative that the phrase following the phrase “in response to” is an example of one of a multitude of suitable possibilities that may, or may not, be employed to one or more of the various embodiments. The phrase “depending on” (or equally “depending at least to”) is indicative that the phrase following the phrase “depending on” is an example of one of a multitude of suitable possibilities that may, or may not, be employed to one or more of the various embodiments. The phrase “employing/using” (or equally “employing/using at least”) is indicative that the phrase following the phrase “employing/using” is an example of one of a multitude of suitable possibilities that may, or may not, be employed to one or more of the various embodiments.

The term configured may relate to the capacity of a device whether the device is in an operational or non-operational state. Configured may refer to specific settings in a device that effect the operational characteristics of the device whether the device is in an operational or non-operational state. In other words, the hardware, software, firmware, registers, memory values, and/or the like may be “configured” within a device, whether the device is in an operational or nonoperational state, to provide the device with specific characteristics. Terms such as “a control message to cause in a device” may mean that a control message has parameters that may be used to configure specific characteristics or may be used to implement certain actions in the device, whether the device is in an operational or non-operational state.

In this disclosure, parameters (or equally called, fields, or Information elements: IEs) may comprise one or more information objects, and an information object may comprise one or more other objects. For example, if parameter (IE) N comprises parameter (IE) M, and parameter (IE) M comprises parameter (IE) K, and parameter (IE) K comprises parameter (information element) J. Then, for example, N comprises K, and N comprises J. In an example embodiment, when one or more messages/frames comprise a plurality of parameters, it implies that a parameter in the plurality of parameters is in at least one of the one or more messages/frames but does not have to be in each of the one or more messages/frames.

Many features presented are described as being optional through the use of “may” or the use of parentheses. For the sake of brevity and legibility, the present disclosure does not explicitly recite each and every permutation that may be obtained by choosing from the set of optional features. The present disclosure is to be interpreted as explicitly disclosing all such permutations. For example, a system described as having three optional features may be embodied in seven ways, namely with just one of the three possible features, with any two of the three possible features or with three of the three possible features.

Many of the elements described in the disclosed embodiments may be implemented as modules. A module is defined here as an element that performs a defined function and has a defined interface to other elements. The modules described in this disclosure may be implemented in hardware, software in combination with hardware, firmware, wetware (e.g. hardware with a biological element) or a combination thereof, which may be behaviorally equivalent. For example, modules may be implemented as a software routine written in a computer language configured to be executed by a hardware machine (such as C, C++, Fortran, Java, Basic, Matlab or the like) or a modeling/simulation program such as Simulink, Stateflow, GNU Octave, or LabVIEWMathScript. It may be possible to implement modules using physical hardware that incorporates discrete or programmable analog, digital and/or quantum hardware. Examples of programmable hardware comprise: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. The mentioned technologies are often used in combination to achieve the result of a functional module.

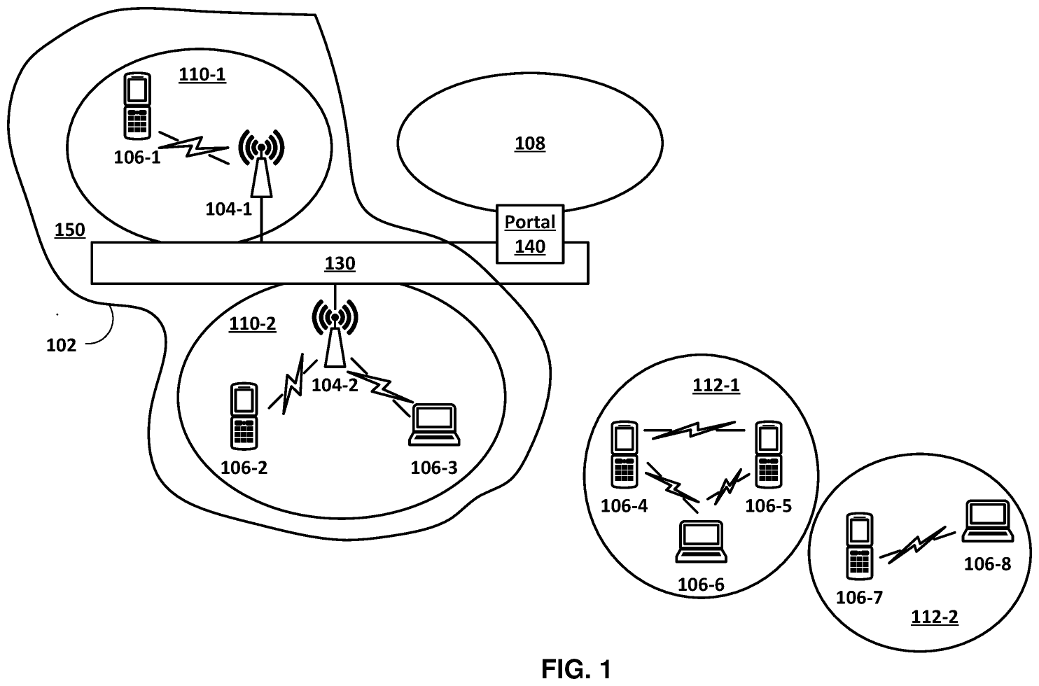

FIG. 1 illustrates example wireless communication networks in which embodiments of the present disclosure may be implemented.

As shown in FIG. 1, the example wireless communication networks may include an Institute of Electrical and Electronic Engineers (IEEE) 802.11 (WLAN) infra-structure network 102. WLAN infra-structure network 102 may include one or more basic service sets (BSSs) 110 and 120 and a distribution system (DS) 130.

BSS 110-1 and 110-2 each includes a set of an access point (AP or AP STA) and at least one station (STA or non-AP STA). For example, BSS 110-1 includes an AP 104-1 and a STA 106-1, and BSS 110-2 includes an AP 104-2 and STAs 106-2 and 106-3. The AP and the at least one STA in a BSS perform an association procedure to communicate with each other.

DS 130 may be configured to connect BSS 110-1 and BSS 110-2. As such, DS 130 may enable an extended service set (ESS) 150. Within ESS 150, APs 104-1 and 104-2 are connected via DS 130 and may have the same service set identification (SSID).

WLAN infra-structure network 102 may be coupled to one or more external networks. For example, as shown in FIG. 1, WLAN infra-structure network 102 may be connected to another network 108 (e.g., 802.X) via a portal 140. Portal 140 may function as a bridge connecting DS 130 of WLAN infra-structure network 102 with the other network 108.

The example wireless communication networks illustrated in FIG. 1 may further include one or more ad-hoc networks or independent BSSs (IBSS s). An ad-hoc network or IBSS is a network that includes a plurality of STAs that are within communication range of each other. The plurality of STAs are configured so that they may communicate with each other using direct peer-to-peer communication (i.e., not via an AP).

For example, in FIG. 1, STAs 106-4, 106-5, and 106-6 may be configured to form a first IBSS 112-1. Similarly, STAs 106-7 and 106-8 may be configured to form a second IBSS 112-2. Since an IBSS does not include an AP, it does not include a centralized management entity. Rather, STAs within an IBSS are managed in a distributed manner. STAs forming an IBSS may be fixed or mobile.

A STA as a predetermined functional medium may include a medium access control (MAC) layer that complies with an IEEE 802.11 standard. A physical layer interface for a radio medium may be used among the APs and the non-AP stations (STAs). The STA may also be referred to using various other terms, including mobile terminal, wireless device, wireless transmit/receive unit (WTRU), user equipment (UE), mobile station (MS), mobile subscriber unit, or user. For example, the term “user” may be used to denote a STA participating in uplink Multi-user Multiple Input, Multiple Output (MU MIMO) and/or uplink Orthogonal Frequency Division Multiple Access (OFDMA) transmission.

A physical layer (PHY) protocol data unit (PPDU) may be a composite structure that includes a PHY preamble and a payload in the form of a PHY service data unit (PSDU). For example, the PSDU may include a PHY preamble and header and/or one or more MAC protocol data units (MPDUs). The information provided in the PHY preamble may be used by a receiving device to decode the subsequent data in the PSDU. In instances in which PPDUs are transmitted over a bonded channel (channel formed through channel bonding), the preamble fields may be duplicated and transmitted in each of the multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is based on the particular IEEE 802.11 protocol to be used to transmit the payload.

A frequency band may include one or more sub-bands or frequency channels. For example, PPDUs conforming to the IEEE 802.11n, 802.11ac, 802.11ax and/or 802.11be standard amendments may be transmitted over the 2.4 GHz, 5 GHz, and/or 6 GHz bands, each of which may be divided into multiple 20 MHz channels. The PPDUs may be transmitted over a physical channel having a minimum bandwidth of 20 MHz. Larger channels may be formed through channel bonding. For example, PPDUs may be transmitted over physical channels having bandwidths of 40 MHz, 80 MHz, 160 MHz, or 320 MHz by bonding together multiple 20 MHz channels.

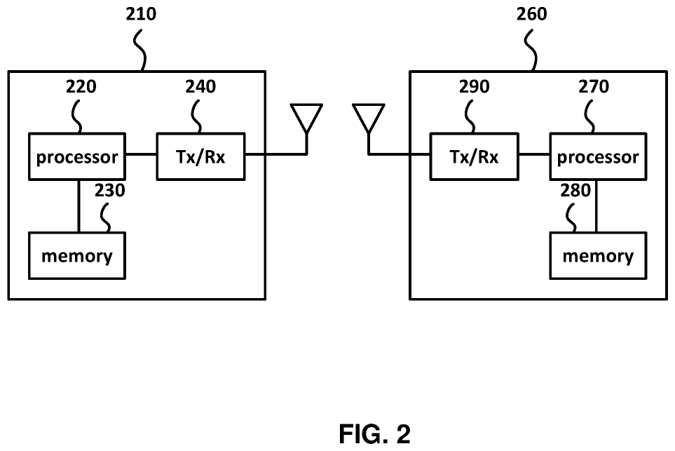

FIG. 2 is a block diagram illustrating example implementations of a STA 210 and an AP 260. As shown in FIG. 2, STA 210 may include at least one processor 220, a memory 230, and at least one transceiver 240. AP 260 may include at least one processor 270, a memory 280, and at least one transceiver 290. Processor 220/270 may be operatively connected to memory 230/280 and/or to transceiver 240/290.

Processor 220/270 may implement functions of the PHY layer, the MAC layer, and/or the logical link control (LLC) layer of the corresponding device (STA 210 or AP 260). Processor 220/270 may include one or more processors and/or one or more controllers. The one or more processors and/or one or more controllers may comprise, for example, a general-purpose processor, a digital signal processor (DSP), a microcontroller, an application specific integrated circuit (ASIC), a field programmable gate array (FPGA), a logic circuit, or a chipset, for example.

Memory 230/280 may include a read-only memory (ROM), a random-access memory (RAM), a flash memory, a memory card, a storage medium, and/or other storage unit. Memory 230/280 may comprise one or more non-transitory computer readable mediums. Memory 230/280 may store computer program instructions or code that may be executed by processor 220/270 to carry out one or more of the operations/embodiments discussed in the present application. Memory 230/280 may be implemented (or positioned) within processor 220/270 or external to processor 220/270. Memory 230/280 may be operatively connected to processor 220/270 via various means known in the art.

Transceiver 240/290 may be configured to transmit/receive radio signals. In an embodiment, transceiver 240/290 may implement a PHY layer of the corresponding device (STA 210 or AP 260). In an embodiment, STA 210 and/or AP 260 may be a multi-link device (MLD), that is a device capable of operating over multiple links as defined by the IEEE 802.11 standard. As such, STA 210 and/or AP 260 may each implement multiple PHY layers. The multiple PHY layers may be implemented using one or more of transceivers 240/290.

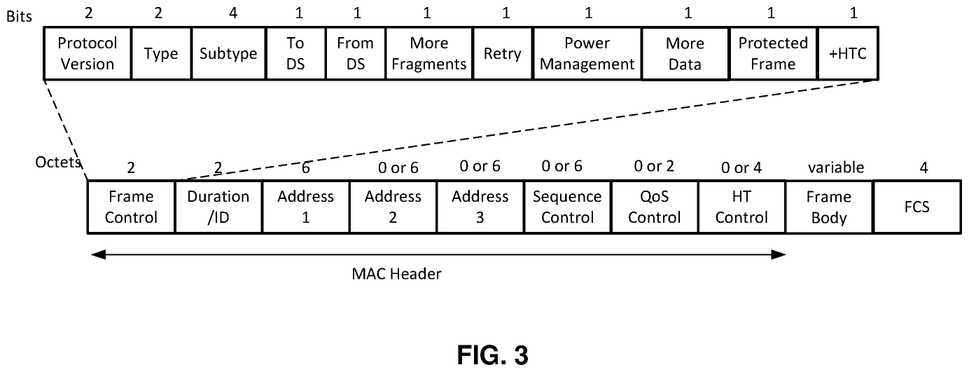

FIG. 3 illustrates an example format of a MAC frame. In operation, a STA may construct a subset of MAC frames for transmission and may decode a subset of received MAC frames upon validation. The particular subsets of frames that a STA may construct and/or decode may be determined by the functions supported by the STA. A STA may validate a received MAC frame using the frame check sequence (FCS) contained in the frame and may interpret certain fields from the MAC headers of all frames.

As shown in FIG. 3, a MAC frame includes a MAC header, a variable length frame body, and a frame check sequence (FCS).

The MAC header includes a frame control field, an optional duration/ID field, address fields, an optional sequence control field, an optional QoS control field, and an optional HT control field.

The frame control fields include the following subfields: protocol version, type, subtype, To DS, From DS, more fragments, retry, power management, more data, protected frame, and +HTC.

The protocol version subfield is invariant in size and placement across all revisions of the IEEE 802.11 standard. The value of the protocol version subfield is 0 for MAC frames.

The type and subtype subfields together identify the function of the MAC frame. There are three frame types: control, data, and management. Each of the frame types has several defined subtypes. Bits within the subtype subfield are used to indicate a specific modification of the basic data frame (subtype 0). For example, in data frames, the most significant bit (MSB) of the subtype subfield, bit 7 (B7) of the frame control field, is defined as the QoS subfield. When the QoS subfield is set to 1, it indicates a QoS subtype data frame, which is a data frame that contains a QoS control field in its MAC header. The second MSB of the subtype field, bit 6 (B6) of the frame control field, when set to 1 in data subtypes, indicates a data frame that contain no frame body field.

The To DS subfield indicates whether a data frame is destined to the distribution system (DS). The From DS subfield indicates whether a data frame originates from the DS.

The more fragments subfield is set to 1 in all data or management frames that have another fragment to follow of the MAC service data unit (MSDU) or MAC management protocol data unit (MMPDU) carried by the MAC frame. It is set to 0 in all other frames in which the more fragments subfield is present.

The retry subfield is set to 1 in any data or management frame that is a retransmission of an earlier frame. It is set to 0 in all other frames in which the retry subfield is present. A receiving STA uses this indication to aid it in the process of eliminating duplicate frames. These rules do not apply for frames sent by a STA under a block agreement.

The power management subfield is used to indicate the power management mode of a STA.

The More Data subfield indicates to a STA in power save (PS) mode that bufferable units (Bus) are buffered for that STA at the AP. The more data subfield is valid in individually addressed data or management frames transmitted by an AP to a STA in PS mode. The more data subfield is set to 1 to indicate that at least one additional buffered BU is present for the STA.

The protected frame subfield is set to 1 if the frame body field contains information that has been processed by a cryptographic encapsulation algorithm.

The +HTC subfield indicates that the MAC frame contains an HT control field.

The duration/ID field of the MAC header indicates various contents depending on frame type and subtype and the QoS capabilities of the sending STA. For example, in control frames of the power save poll (PS-Poll) subtype, the duration/ID field carries an association identifier (AID) of the STA that transmitted the frame in the 14 least significant bits (LSB), and the 2 most significant bits (MSB) are both set to 1. In other frames sent by STAs, the duration/ID field contains a duration value (in microseconds) which is used by a recipient to update a network allocation vector (NAV). The NAV is a counter that it indicates to a STA an amount of time during which it must defer from accessing the shared medium.

There can be up to four address fields in the MAC frame format. These fields are used to indicate the basic service set identifier (BSSID), source address (SA), destination address (DA), transmitting address (TA), and receiving address (RA). Certain frames might not contain some of the address fields. Certain address field usage may be specified by the relative position of the address field (1-4) within the MAC header, independent of the type of address present in that field. Specifically, the address 1 field always identifies the intended receiver(s) of the frame, and the address 2 field, where present, always identifies the transmitter of the frame.

The sequence control field includes two subfields, a sequence number subfield and a fragment number subfield. The sequence number subfield in data frames indicates the sequence number of the MSDU (if not in an Aggregated MSDU (A-MSDU)) or A-MSDU. The sequence number subfield in management frames indicates the sequence number of the frame. The fragment number subfield indicates the number of each fragment of an MSDU or MMPDU. The fragment number is set to 0 in the first or only fragment of an MSDU or MMPDU and is incremented by one for each successive fragment of that MSDU or MMPDU. The fragment number is set to 0 in a MAC protocol data unit (MPDU) containing an A-MSDU, or in an MPDU containing an MSDU or MMPDU that is not fragmented. The fragment number remains constant in all retransmissions of the fragment.

The QoS control field identifies the traffic category (TC) or traffic stream (TS) to which the MAC frame belongs. The QoS control field may also indicate various other QoS related, A-MSDU related, and mesh-related information about the frame. This information can vary by frame type, frame subtype, and type of transmitting STA. The QoS control field is present in all data frames in which the QoS subfield of the subtype subfield is equal to 1.

The HT control field is present in QoS data, QoS null, and management frames as determined by the +HTC subfield of the frame control field.

The frame body field is a variable length field that contains information specific to individual frame types and subtypes. It may include one or more MSDUs or MMPDUs. The minimum length of the frame body is 0 octets.

The FCS field contains a 32-bit Cyclic Redundancy Check (CRC) code. The FCS field value is calculated over all of the fields of the MAC header and the frame body field.

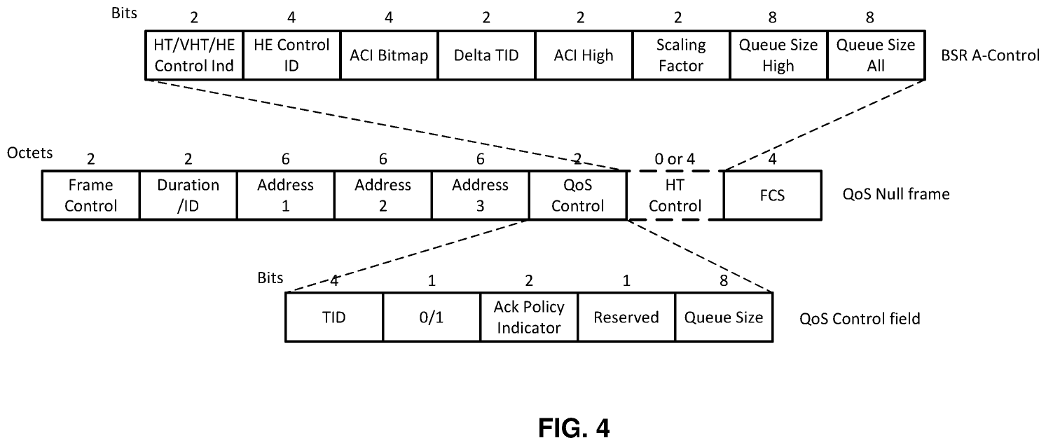

FIG. 4 illustrates an example of a QoS null frame indicating buffer status information. A QoS null frame refers to a QoS data frame with an empty frame body. A QoS null frame includes a QoS control field and an optional HT control field which may contain a buffer status report (BSR) control subfield. A QoS null frame indicating buffer status information may be transmitted by a STA to an AP.

The QoS control field may include a traffic identifier (TID) subfield, an ack policy indicator subfield, and a queue size subfield (or a transmission opportunity (TXOP) duration requested subfield).

The TID subfield identifies the TC or TS of traffic for which a TXOP is being requested, through the setting of the TXOP duration requested or queue size subfield. The encoding of the TID subfield depends on the access policy (e.g., Allowed value 0 to 7 for enhanced distributed channel access (EDCA) access policy to identify user priority for either TC or TS).

The ack policy indicator subfield, together with other information, identifies the acknowledgment policy followed upon delivery of the MPDU (e.g., normal ack, implicit block ack request, no ack, block ack, etc.)

The queue size subfield is an 8-bit field that indicates the amount of buffered traffic for a given TC or TS at the STA for transmission to the AP identified by the receiver address of the frame containing the subfield. The queue size subfield is present in QoS null frames sent by a STA when bit 4 of the QoS control field is set to 1. The AP may use information contained in the queue size subfield to determine t TXOP duration assigned to the STA or to determine the uplink (UL) resources assigned to the STA.

In a frame sent by or to a non-High Efficiency (non-HE) STA, the following rules may apply to the queue size value:
The queue size value is the approximate total size, rounded up to the nearest multiple of 256 octets and expressed in units of 256 octets, of all MSDUs and A-MSDUs buffered at the STA (excluding the MSDU or A-MSDU contained in the present QoS Data frame) in the delivery queue used for MSDUs and A-MSDUs with TID values equal to the value indicated in the TID subfield of the QoS Control field.
A queue size value of 0 is used solely to indicate the absence of any buffered traffic in the queue used for the specified TID.
A queue size value of 254 is used for all sizes greater than 64 768 octets.
A queue size value of 255 is used to indicate an unspecified or unknown size.

In a frame sent by an HE STA to an HE AP, the following rules may apply to the queue size value.

The queue size value, QS, is the approximate total size in octets, of all MSDUs and A-MSDUs buffered at the STA (including the MSDUs or A-MSDUs contained in the same PSDU as the frame containing the queue size subfield) in the delivery queue used for MSDUs and A-MSDUs with TID values equal to the value indicated in the TID subfield of the QoS control field.

The queue size subfield includes a scaling factor subfield in bits B14B15 of the QoS control field and an unscaled value, UV, in bits B8B13 of the QoS control field. The scaling factor subfield provides the scaling factor, on.

A STA obtains the queue size, QS, from a received QoS control field, which contains a scaling factor, SF, and an unscaled value, UV, as follows:

### QS=

16×UV, if SF is equal to 0;
1024+256×UV, if SF is equal to 1;
17 408+2048×UV, if SF is equal to 2;
148 480+32 768×UV, if SF is equal to 3 and UV is less than 62;
>2 147 328, if SF equal to is 3 and UV is equal to 62;
Unspecified or Unknown, if SF is equal to 3 and UV is equal to 63.

The TXOP duration requested subfield, which may be included instead of the queue size subfield, indicates the duration, in units of 32 microseconds (us), that the sending STA determines it needs for its next TXOP for the specified TID. The TXOP duration requested subfield is set to 0 to indicate that no TXOP is requested for the specified TID in the current service period (SP). The TXOP duration requested subfield is set to a nonzero value to indicate a requested TXOP duration in the range of 32 us to 8160 us in increments of 32 us.

The HT control field may include a BSR control subfield which may contain buffer status information used for uplink (UL) multi-user (MU) operation. The BSR control subfield may be formed from an access category index (ACI) bitmap subfield, a delta TID subfield, an ACI high subfield, a scaling factor subfield, a queue size high subfield, and a queue size all subfield of the HT control field.

The ACI bitmap subfield indicates the access categories for which buffer status is reported (e.g., B0: best effort (AC_BE), B1: background (AC_BK), B2: video (AC_VI), B3: voice (AC_VO), etc.). Each bit of the ACI bitmap subfield is set to 1 to indicate that the buffer status of the corresponding AC is included in the queue size all subfield, and set to 0 otherwise, except that if the ACI bitmap subfield is 0 and the delta TID subfield is 3, then the buffer status of all 8 TIDs is included.

The delta TID subfield, together with the values of the ACI bitmap subfield, indicate the number of TIDs for which the STA is reporting the buffer status.

The ACI high subfield indicates the ACI of the AC for which the BSR is indicated in the queue size high subfield. The ACI to AC mapping is defined as ACI value 0 mapping to AC_BE, ACI value 1 mapping to AC_BK, ACI value 2 mapping to AC_VI, and ACI value 3 mapping to AC_VO.

The scaling factor subfield indicates the unit SF, in octets, of the queue size high and queue size all subfields.

The queue size high subfield indicates the amount of buffered traffic, in units of SF octets, for the AC identified by the ACI high subfield, that is intended for the STA identified by the receiver address of the frame containing the BSR control subfield.

The queue size all subfield indicates the amount of buffered traffic, in units of SF octets, for all Acs identified by the ACI Bitmap subfield, that is intended for the STA identified by the receiver address of the frame containing the BSR control subfield.

The queue size values in the queue size high and queue size all subfields are the total sizes, rounded up to the nearest multiple of SF octets, of all MSDUs and A-MSDUs buffered at the STA (including the MSDUs or A-MSDUs contained in the same PSDU as the frame containing the BSR control subfield) in delivery queues used for MSDUs and A-MSDUs associated with AC(s) that are specified in the ACI high and ACI bitmap subfields, respectively.

A queue size value of 254 in the queue size high and queue size all subfields indicates that the amount of buffered traffic is greater than 254×SF octets. A queue size value of 255 in the queue size high and queue size all subfields indicates that the amount of buffered traffic is an unspecified or unknown size. The queue size value of QoS data frames containing fragments may remain constant even if the amount of queued traffic changes as successive fragments are transmitted.

MAC service provides peer entities with the ability to exchange MSDUs. To support this service, a local MAC uses the underlying PHY-level service to transport the MSDUs to a peer MAC entity. Such asynchronous MSDU transport is performed on a connectionless basis.

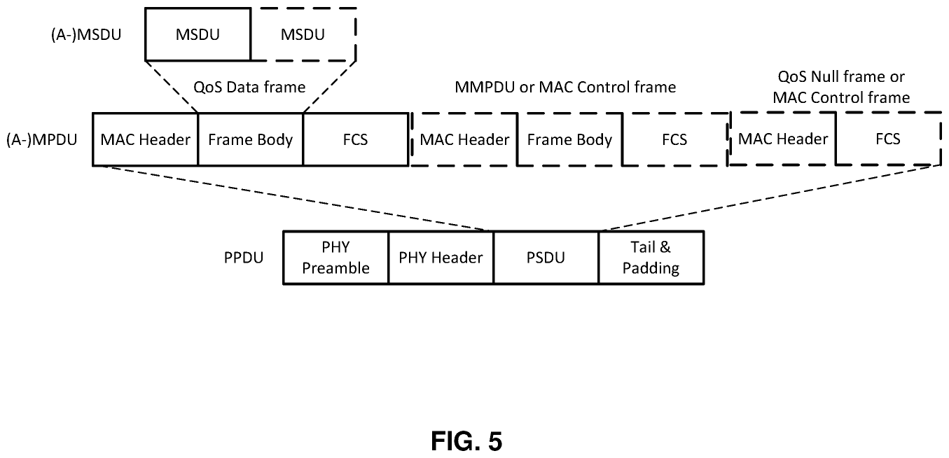

FIG. 5 illustrates an example format of a PPDU. As shown, the PPDU may include a PHY preamble, a PHY header, a PSDU, and tail and padding bits.

The PSDU may include one or more MPDUs, such as a QoS data frame, an MMPDU, a MAC control frame, or a QoS null frame. In the case of an MPDU carrying a QoS data frame, the frame body of the MPDU may include a MSDU or an A-MSDU.

By default, MSDU transport is on a best-effort basis. That is, there is no guarantee that a transmitted MSDU will be delivered successfully. However, the QoS facility uses a traffic identifier (TID) to specify differentiated services on a per-MSDU basis.

A STA may differentiate MSDU delivery according to designated traffic category (TC) or traffic stream (TS) of individual MSDUs. The MAC sublayer entities determine a user priority (UP) for an MSDU based on a TID value provided with the MSDU. The QoS facility supports eight UP values. The UP values range from 0 to 7 and form an ordered sequence of priorities, with 1 being the lowest value, 7 the highest value, and 0 falling between 2 and 3.

An MSDU with a particular UP is said to belong to a traffic category with that UP. The UP may be provided with each MSDU at the medium access control service access point (MAC SAP) directly in a UP parameter. An aggregate MPDU (A-MPDU) may include MPDUs with different TID values.

A STA may deliver buffer status reports (BSRs) to assist an AP in allocating UL MU resources. The STA may either implicitly deliver BSRs in the QoS control field or BSR control subfield of any frame transmitted to the AP (unsolicited BSR) or explicitly deliver BSRs in a frame sent to the AP in response to a BSRP Trigger frame (solicited BSR).

The buffer status reported in the QoS control field includes a queue size value for a given TID. The buffer status reported in the BSR control field includes an ACI bitmap, delta TID, a high priority AC, and two queue sizes.

A STA may report buffer status to the AP, in the QoS control field, of transmitted QoS null frames and QoS data frames and, in the BSR control subfield (if present), of transmitted QoS null frames, QoS data frames, and management frames as defined below.

The STA may report the queue size for a given TID in the queue size subfield of the QoS control field of transmitted QoS data frames or QoS null frames; the STA may set the queue size subfield to 255 to indicate an unknown/unspecified queue size for that TID. The STA may aggregate multiple QoS data frames or QoS null frames in an A-MPDU to report the queue size for different TIDs.

The STA may report buffer status in the BSR control subfield of transmitted frames if the AP has indicated its support for receiving the BSR control subfield.

A High-Efficiency (HE) STA may report the queue size for a preferred AC, indicated by the ACI high subfield, in the queue size high subfield of the BSR control subfield. The STA may set the queue size high subfield to 255 to indicate an unknown/unspecified queue size for that AC.

A HE STA may report the queue size for ACs indicated by the ACI bitmap subfield in the queue size all subfield of the BSR control subfield. The STA may set the queue size all subfield to 255 to indicate an unknown/unspecified BSR for those ACs.

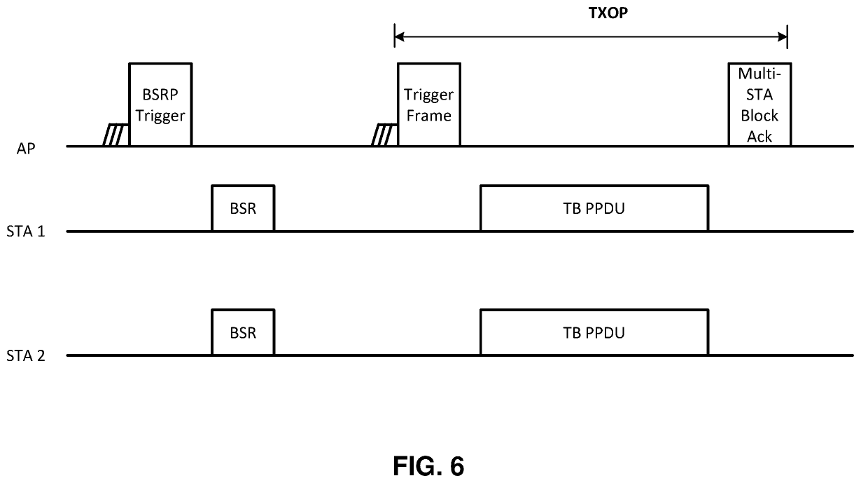

FIG. 6 illustrates an example that includes buffer status reporting by STAs, scheduling by an AP of uplink multi-user (MU) transmissions, and transmission of scheduled uplink transmissions by the STAs.

As shown, the AP may solicit one or more associated STAs (STA 1 and STA 2) for buffer status by sending a buffer status report poll (BSRP) trigger frame. Upon receiving the BSRP trigger frame, STA 1 and/or STA 2 may each generate a trigger-based (TB) PPDU if the BSRP trigger frame contains, in a User Info field, the 12 LSBs of the STA's AID.

STA 1 and/or STA 2 may each include in the TB PPDU one or more QoS null frames. The one or more QoS null frames may contain one or more QoS control fields or one or more BSR control subfields.

As described earlier, a QoS control field may include a queue size subfield for a TID for which the STA has a queue size to report to the AP. For example, as shown in FIG. 6, STA 1 may respond to the BSRP trigger frame from the AP by transmitting an A-MPDU including multiple QoS null frames. The QoS null frames each indicates, in its respective QoS control field, a queue size for a respective TID, e.g. TID 0 and TID 2. Similarly, STA 2 may respond to the BSRP trigger frame by transmitting an MPDU including a QoS null frame, which indicates a queue size for TID 2 in its QoS control field.

A BSR control subfield may include a queue size all subfield indicating the queue size for the ACs, indicated by the ACI bitmap subfield, for which the STA has a queue size to report to the AP if the AP has indicated its support for receiving the BSR control subfield. The STA sets a delta TID, a scaling factor, an ACI high, and the queue size high subfields of the BSR Control subfield.

On receiving the BSRs from STA 1 and STA 2, the AP may transmit a basic trigger frame to allocate UL MU resources to STA 1 and STA 2. In response, STA 1 may transmit a TB PPDU containing QoS data frames with TID 0 and TID 2 and STA 2 may transmit a TB PPDU containing one or more QoS data frame(s) with TID 2. The AP may acknowledge the transmitted TB PPDUs from STA 1 and STA 2 by sending a multi-STA block ack frame.

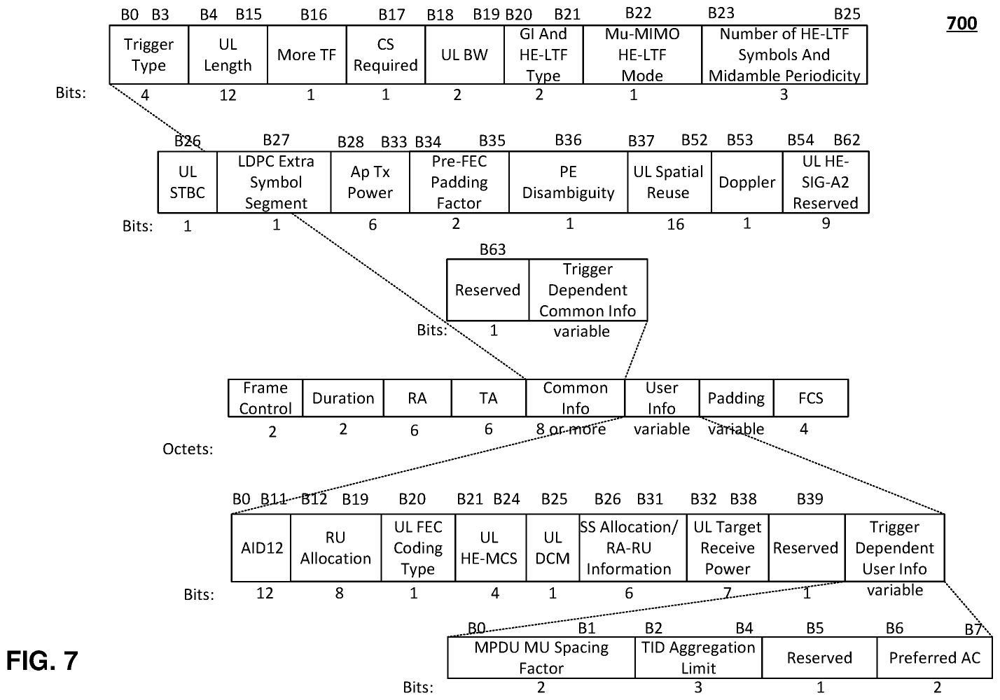

FIG. 7 illustrates an example 700 of a trigger frame format. Trigger frame 700 may correspond to a basic trigger frame as defined in the existing IEEE 802.11ax standard amendment. Trigger frame 700 may be used by an AP to allocate resources for and solicit one or more TB PPDU transmissions from one or more STAs. Trigger frame 700 may also carry other information required by a responding STA to transmit a TB PPDU to the AP.

As shown in FIG. 7, trigger frame 700 includes a Frame Control field, a Duration field, a receiver address (RA) field, a transmitter address (TA) field, a Common Info field, a User Info field, a Padding field, and an FCS field.

The Frame Control field includes the following subfields: protocol version, type, subtype, To DS, From DS, more fragments, retry, power management, more data, protected frame, and +HTC.

The Duration field indicates various contents depending on frame type and subtype and the QoS capabilities of the sending STA. For example, in control frames of the power save poll (PS-Poll) subtype, the Duration field carries an association identifier (AID) of the STA that transmitted the frame in the 14 least significant bits (LSB), and the 2 most significant bits (MSB) are both set to 1. In other frames sent by STAs, the Duration field contains a duration value (in microseconds) which is used by a recipient to update a network allocation vector (NAV).

The RA field is the address of the STA that is intended to receive the incoming transmission from the transmitting station. The TA field is the address of the STA transmitting trigger frame 700 if trigger frame 700 is addressed to STAs that belong to a single BSS. The TA field is the transmitted BSSID if the trigger frame 700 is addressed to STAs from at least two different BSSs of the multiple BSSID set.

The Common Info field specifies a trigger frame type of trigger frame 700, a transmit power of trigger frame 700 in dBm, and several key parameters of a TB PPDU that is transmitted by a STA in response to trigger frame 700. The trigger frame type of a trigger frame used by an AP to receive QoS data using UL MU operation is referred to as a basic trigger frame.

The User Info field contains a User Info field per STA addressed in trigger frame 700. The per STA User Info field includes, among others, an AID subfield, an RU Allocation subfield, a Spatial Stream (SS) Allocation subfield, an MCS subfield to be used by a STA in a TB PPDU transmitted in response to trigger frame 700, and a Trigger Dependent User Info subfield. The Trigger Dependent User Info subfield i can be used by an AP to specify a preferred access category (AC) per STA. The preferred AC sets the minimum priority AC traffic that can be sent by a participating STA. The AP determines the list of participating STAs, along with the BW, MCS, RU allocation, SS allocation, Tx power, preferred AC, and maximum duration of the TB PPDU per participating STA.

The Padding field is optionally present in trigger frame 700 to extend the frame length to give recipient STAs enough time to prepare a response for transmission one SIFS after the frame is received. The Padding field, if present, is at least two octets in length and is set to all 1 s.

The FCS field is used by a STA to validate a received frame and to interpret certain fields from the MAC headers of a frame.

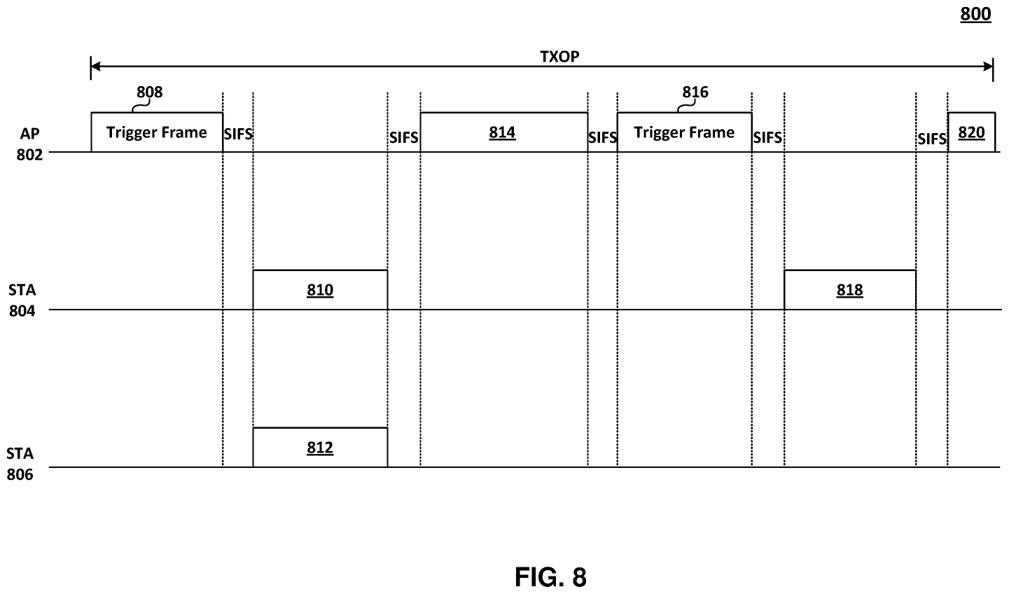

FIG. 8 illustrates an example 800 of uplink transmission in response to a trigger frame. As shown in FIG. 8, example 800 includes an AP 802, a STA 804, and a STA 806. In an example, STAs 804 and 806 may be associated with AP 802.

In an example, AP 802 may obtain a TXOP and transmit a basic trigger frame 808 to STA 804 and STA 806. Trigger frame 808 may identify STAs 804 and 806 and may allocate a first resource (e.g., resource unit (RU) and/or spatial stream) to STA 804 and a second resource to STA 806.

In response to trigger frame 808, STA 804 may transmit, via the first resource, a TB PPDU 810 to AP 802, and STA 806 may transmit, via the second resource, a TB PPDU 812 to AP 802. STAs 804 and 806 may transmit TB PDDUs 810 and 812 one Short Inter-Frame Spacing (SIFS) after reception of trigger frame 808.

Assuming all MPDUs contained in TB PDDUs 810 and 812 are successfully received, AP 802 may acknowledge TB PDDUs 810 and 812 by transmitting a multi-STA BlockAck (BA) frame 814 to STAs 804 and 806. AP 802 may transmit multi-STA BA frame 814 one SIFS after reception of TB PPDUs 810 and 812. In another example, AP 802 may acknowledge TB PDDUs 810 and 812 by transmitting a separate BA frame to each of STAs 804 and 806.

According to the existing IEEE 802.11ax/be standard amendments, to allocate to a STA, using a trigger frame, multiple resources for multiple uplink transmissions in time (e.g., an initial transmission and one or more subsequent transmissions or re-transmissions), an AP must transmit multiple trigger frames to the STA each allocating a respective resource for a respective uplink transmission. For example, referring to FIG. 8, to allocate a further resource to STA 804 (after transmission of TB PDDU 810, via the first resource, by STA 804), AP 802 would need to transmit a further trigger frame 816 identifying STA 804 and assigning the further resource to STA 804. STA 804 may then transmit a further TB PDDU 818, via the assigned further resource, to AP 802. STA 804 may transmit TB PPDU 818 one SIFS after receiving trigger frame 816. AP 802 may acknowledge TB PDDU 818 by transmitting a BA frame 820 to STA 804.

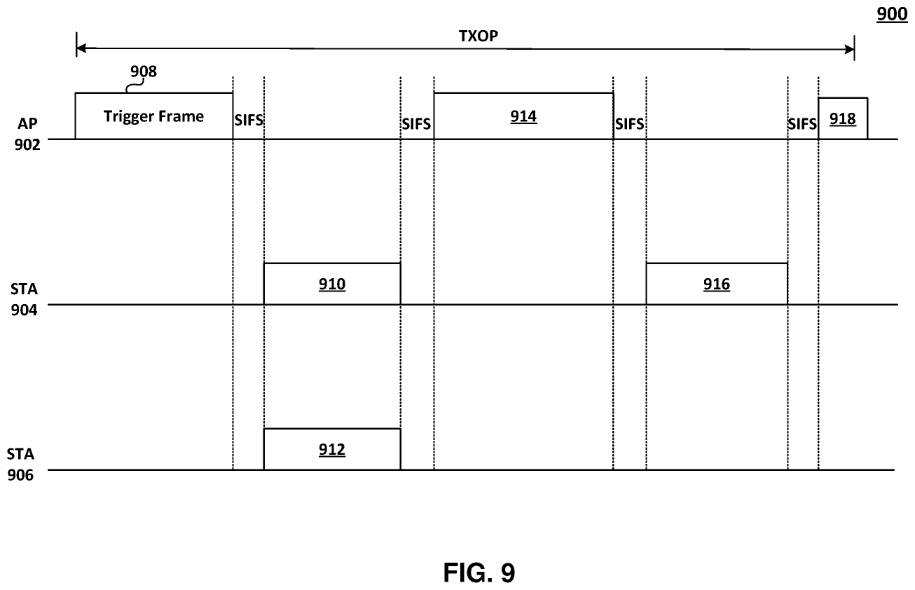

FIG. 9 illustrates an example 900 of uplink transmission in response to a trigger frame according to an embodiment. Example 900 is provided for the purpose of illustration only and is not limiting of embodiments of the present disclosure. As shown in FIG. 9, example 900 includes an AP 902, a STA 904, and a STA 906. In an example, STAs 904 and 906 may be associated with AP 902.

In an example, AP 902 may obtain a TXOP and transmit a trigger frame 908 to STAs 904 and 906. Trigger frame 908 may be a frame that solicits one or more trigger-based (TB) physical layer (PHY) protocol data unit (PPDU) from one or more of STAs 904 and 906.

In an embodiment, trigger frame 908 includes a first indication associated with a first uplink resource allocation for the STA 904; and a second indication associated with a second uplink resource allocation for STA 904. In an embodiment, an uplink resource allocation may include a frequency resource and/or a spatial resource. The uplink resource allocation is associated with a time resource associated with a transmission interval.

A frequency resource may include a resource unit (RU), which includes one or more tones or frequency subcarriers.

A spatial resource may include one or more spatial dimensions. A spatial dimension may be created by the use of multiple antennas at both ends of a communication link. A spatial stream may comprise a bit stream or modulated symbols transmitted over a respective spatial dimension.

In an embodiment, the first uplink resource allocation and the second resource uplink allocation contained in trigger frame 908 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a time division duplex (TDD) slot as defined in the IEEE 802.11 standard. In another embodiment, the first/second transmission interval may correspond in duration to a portion of a TDD slot as defined in the IEEE 802.11 standard.

In response to trigger frame 908, STA 904 may transmit a frame 910, via the first uplink resource allocation, to AP 902. Frame 910 may include a TB PPDU. In an embodiment, the first time resource associated with the first uplink resource allocation starts at a first time spacing from an end of transmission of trigger frame 908. In an embodiment, as shown in FIG. 9, the first time spacing equals a short interframe spacing (SIFS) duration, and frame 910 is transmitted one SIFS after transmission of trigger frame 908.

In an embodiment, trigger frame 908 may further include a third indication associated with a third uplink resource allocation for STA 906. In an embodiment, as shown in FIG. 9, the third uplink resource allocation may be associated with a same time resource as the first uplink resource allocation allocated to STA 904. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 904. The third uplink resource allocation may be associated with a different frequency resource and/or a different spatial resource than the second uplink resource allocation.

In response to trigger frame 908, STA 906 may transmit a frame 912, via the third uplink resource allocation, to AP 902. Frame 912 may include a TB PPDU. In an embodiment, the time resource associated with the third resource allocation starts at a third time spacing from an end of transmission of trigger frame 908. In an embodiment, as shown in FIG. 9, the third time spacing equals a short interframe spacing (SIFS) duration, and frame 912 is transmitted one SIFS after transmission of trigger frame 908.

In an embodiment, AP 902 may transmit a frame 914 after receiving frames 910 and 912 from STAs 904 and 906 respectively. Frame 914 may include a BlockAck (BA) frame or a multi-STA BA frame. In an embodiment, frame 914 may be transmitted one SIFS after reception of frames 910 and 912 by AP 902.

In an embodiment, upon receiving frame 914 from AP 902, STA 904 may transmit a frame 916, via the second uplink resource allocation, to AP 902. Frame 916 may include a TB PPDU. In an embodiment, the second time resource associated with the second uplink resource allocation starts at a second time spacing from an end of transmission of frame 914 transmitted by AP 902 in response to frames 910 and 912. In an embodiment, as shown in FIG. 9, the second time spacing equals a SIFS duration, and frame 916 is transmitted one SIFS after reception of frame 914 by STA 904.

In an embodiment, in response to frame 916, AP 902 may transmit a frame 918 to STA 904. Frame 918 may be a BA frame acknowledging frame 916.

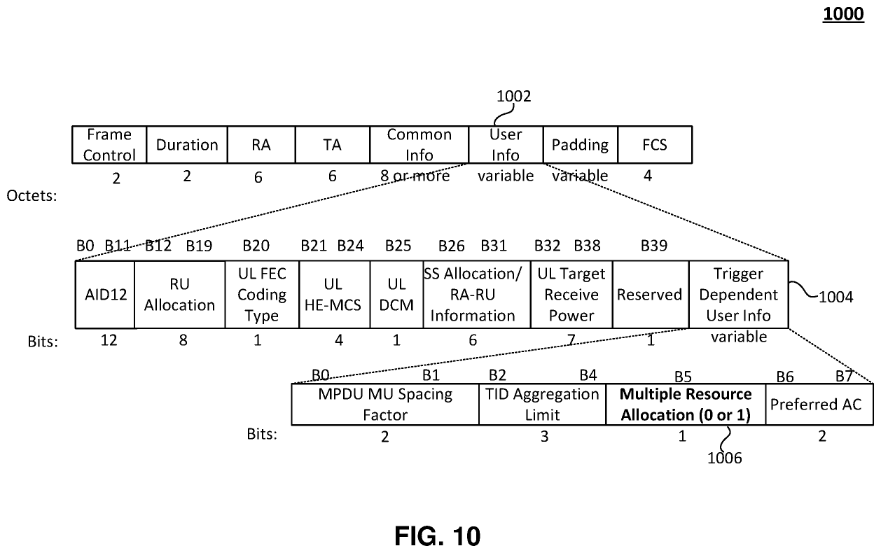

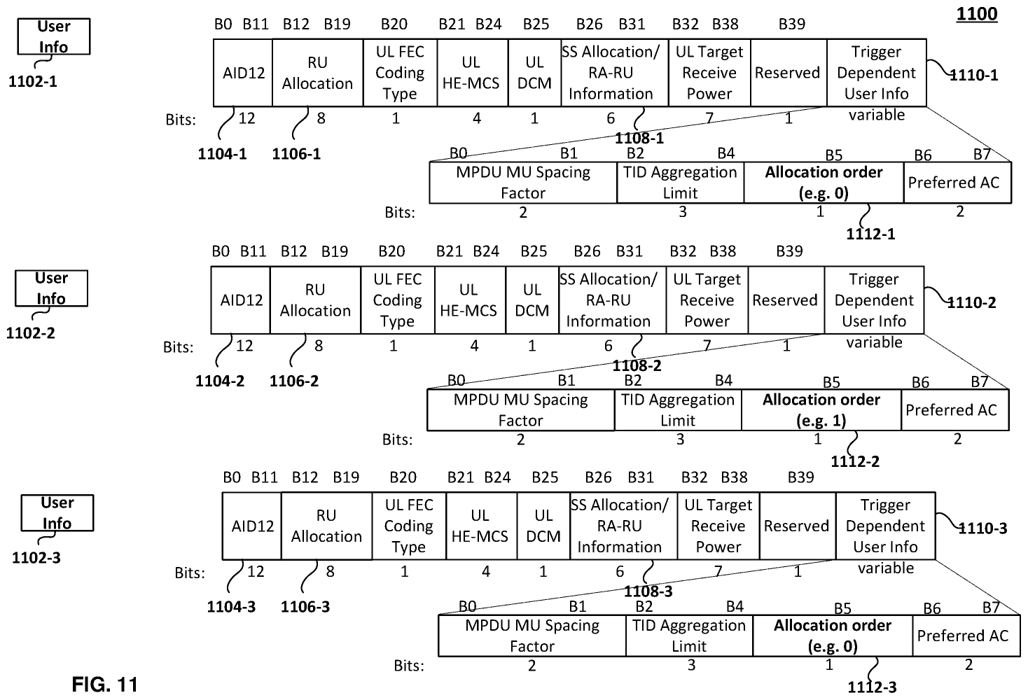

As described above, a trigger frame according to embodiments may include a first indication associated with a first uplink resource allocation for a STA; and a second indication associated with a second uplink resource allocation for the STA. FIGS. 10 and 11 described below provide example trigger frame formats which may be used to implement embodiments of the present disclosure.

FIG. 10 illustrates an example 1000 of a trigger frame format according to an embodiment. Example trigger frame 1000 is provided for the purpose of illustration only and is not limiting of embodiments. Example trigger frame 1000 may be a modified version of a basic trigger frame as defined in the existing IEEE 802.11ax standard amendment. Specifically, trigger frame 1000 may include a modified User Info field 1002, a modified Trigger Dependent User Info subfield 1004 (within the modified user info field 1002), and a new Multiple Resource Allocation subfield 1006 (within the modified Trigger Dependent User Info subfield 1004). Multiple Resource Allocation subfield 1006 replaces a Reserved Bit of the Trigger Dependent User Info subfield of the (User Info field of) existing basic trigger frame.

In an embodiment, an RU Allocation subfield and/or an SS (Spatial Stream) Allocation subfield of User Info field 1002 may carry the first indication associated with the first uplink resource allocation. For example, when the first uplink resource allocation includes a frequency resource, the RU Allocation subfield may include a value that maps to an RU index associated with an RU being allocated to the STA. In another example, when the first uplink resource allocation includes a spatial resource, the SS Allocation subfield may include a first value corresponding to a starting spatial stream and a second value corresponding to a number of spatial streams allocated to the STA (the first value and the second value are hereinafter referred to as a spatial stream allocation).

In an embodiment, the Multiple Resource Allocation subfield 1006 may carry the second indication associated with the second uplink resource allocation. Specifically, in an embodiment, the Multiple Resource Allocation subfield 1006 comprises an indication of presence or absence of the second uplink resource allocation in trigger frame 1000.

In an embodiment, the Multiple Resource Allocation subfield 1006 may take a value of 0 to indicate absence of the second uplink resource allocation in trigger frame 1000. As such, the STA is allocated a single resource allocation in trigger frame 1000.

In an embodiment, the Multiple Resource Allocation subfield 1006 may take a value of 1 to indicate presence of, and to implicitly signal, the second uplink resource allocation in trigger frame 1000. In an embodiment, when the Multiple Resource Allocation subfield 1006 is equal to 1, the STA assumes that the frequency resource and/or the spatial resource associated with the second uplink resource allocation are equal to the frequency resource and/or the spatial resource associated with the first uplink resource allocation. In another embodiment, when the Multiple Resource Allocation subfield 1006 is equal to 1, the STA determines the frequency resource and/or the spatial resource associated with the second uplink resource allocation based on the frequency resource and/or the spatial resource associated with the first uplink resource allocation. For example, the STA may use a predetermined rule to determine the frequency resource and/or the spatial resource associated with the second uplink resource allocation based on the frequency resource and/or the spatial resource associated with the first uplink resource allocation (e.g., if the frequency resource associated with the first uplink resource allocation is equal to RUᵢ, then the frequency resource associated with the first uplink resource allocation may be equal to f(RUᵢ), where f( ) is a function representing the predetermined rule).

As shown in FIG. 10, User Info field 1002 is a variable field such that it may include multiple User Info fields 1002 for multiple STAs. According to embodiments, trigger frame 1000 may thus be used to signal resource allocations for multiple STAs at the same time. The resource allocation for a given STA of the multiple STAs may include a single resource allocation or multiple resource allocations as described above.

FIG. 11 illustrates an example of a trigger frame format 1100 according to an embodiment. Example trigger frame 1100 is provided for the purpose of illustration only and is not limiting of embodiments. Example trigger frame 1100 may be a modified version of a basic trigger frame as defined in the existing IEEE 802.11ax standard amendment.

As shown in FIG. 11, trigger frame 1100 may include multiple User Info fields 1102-1, 1102-2, and 1102-3. In an embodiment, User Info fields 1102-1 and 1102-2 may be associated with a same first STA being allocated by the AP, while User Info field 1102-3 may be associated with a second STA being allocated by the AP in trigger frame 1100.

A User Info field 1102 of trigger frame 1100 may be a modified version of the User Info field of the basic trigger frame. Specifically, a User Info field 1102 may include, among others, an AID12 subfield 1104, an RU Allocation subfield 1106, an SS Allocation subfield 1108, a modified Trigger Dependent User Info subfield 1110.

The AID12 subfield 1104 includes an association identifier (AID) of the STA being allocated by the User Info field 1102. For example, in example trigger frame 1100, AID12 subfields 1104-1 and 1104-2 may include the AID of the first STA being allocated by the AP, and AID subfield 1104-3 may include the AID of the second STA being allocated by the AP.

The RU Allocation subfield 1106 and/or the SS Allocation subfield 1108 may carry an indication associated with an uplink resource allocation for the STA being allocated by the User Info field 1102. For example, when the uplink resource allocation includes a frequency resource, the RU Allocation subfield 1106 may include a value that maps to an RU index associated with an RU being allocated to the STA. In another example, when the uplink resource allocation includes a spatial resource, the SS Allocation subfield 1108 may include a first value corresponding to a starting spatial stream and a second value corresponding to a number of spatial streams allocated to the STA.

In an embodiment, when trigger frame 1100 includes multiple User Info fields 1102 for a STA, the first occurring User Info field (e.g., User Info field 1102-1) among the multiple User Info fields for the STA may include a first indication associated with a first uplink resource allocation for the STA. A subsequent User Info field (e.g., User Info field 1102-2) among the multiple User Info fields for the STA may include a second indication associated with a second uplink resource allocation for the STA.

In another embodiment, when trigger frame 1100 includes multiple User Info fields 1102 for a STA, an Allocation Order subfield 1112 of the Trigger Dependent User Info subfield 1110 may be used to associate the indication of uplink resource allocation contained in the User Info field with a respective time resource. For example, in example trigger frame 1100, Allocation Order subfield 1112-1 of Trigger Dependent User Info subfield 1110-1 may have a value of 0, thereby associating the first indication associated with the first uplink resource allocation contained in User Info field 1102-1 with a first time resource. In an embodiment, the first time resource may start at a first time spacing from an end of transmission of trigger frame 1100. Allocation Order subfield 1112-2 of Trigger Dependent User Info subfield 1110-2 may have a value of 1, thereby associating the second indication of the second uplink resource allocation contained in User Info field 1102-2 with a second time resource. The second time resource associated may start at a second time spacing from an end of transmission of a frame (e.g., BA or multi-STA BA) that is transmitted by the AP in response to a frame transmitted by the AP via the first resource allocation (e.g., TB PPDU).

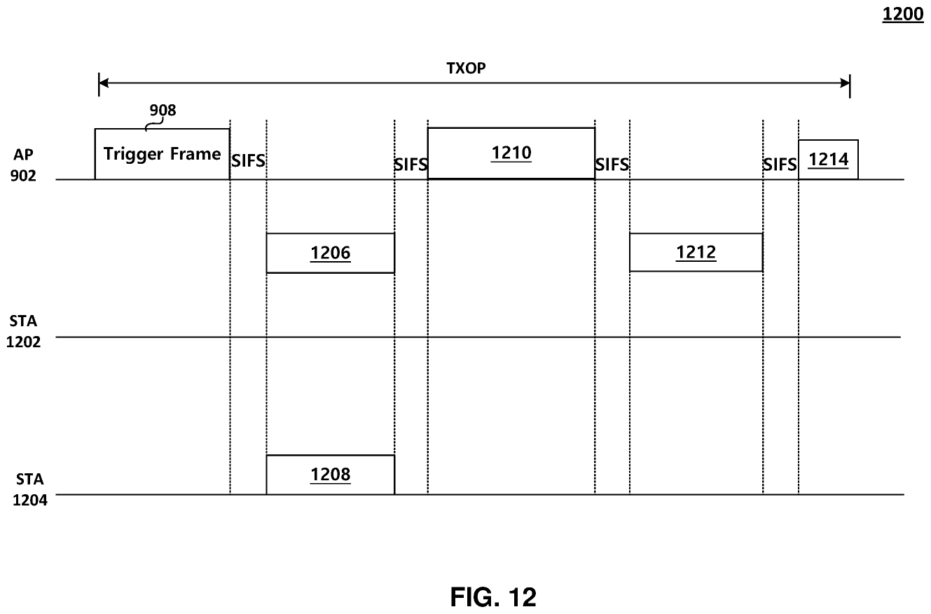

FIG. 12 illustrates an example 1200 of uplink transmission in response to a trigger frame according to an embodiment. Example 1200 is provided for the purpose of illustration only and is not limiting of embodiments of the present disclosure. As shown in FIG. 12, example 1200 includes AP 902, a STA 1202, and a STA 1204. In an example, STAs 1202 and 1204 may be associated with AP 902.

In an example, AP 902 may obtain a TXOP and transmit a trigger frame 908 to STAs 1202 and 1204. Trigger frame 908 may solicit one or more TB PPDUs from one or more of STAs 1202 and 1204.

In an embodiment, trigger frame 908 includes a first indication associated with a first uplink resource allocation for STA 1202; and a second indication associated with a second uplink resource allocation for STA 1202. In an embodiment, an uplink resource allocation may include a frequency resource and/or spatial resource.

In an embodiment, trigger frame 908 may have a format according to trigger frame 1000 described above. As such, the first indication associated with the first uplink resource allocation for STA 1202 may be carried by an RU Allocation subfield and/or an SS Allocation subfield of a User Info field of trigger frame 908. For example, when the first uplink resource allocation includes a frequency resource, the RU Allocation subfield may include a value that maps to an RU index associated with an RU being allocated to STA 1202. In another example, when the first uplink resource allocation includes a spatial resource, the SS Allocation subfield may include a first value corresponding to a starting spatial stream and a second value corresponding to a number of spatial streams allocated to STA 1202. The second indication associated with the second uplink resource allocation for STA 1202 may be carried in a Multiple Resource Allocation subfield of trigger frame 908.

In an embodiment, as shown in FIG. 12, AP 902 may allocate both a first uplink resource allocation and a second uplink resource allocation to STA 1202. The first uplink resource allocation may be signaled by the RU Allocation subfield and/or the SS Allocation subfield. For example, the RU Allocation subfield may indicate a first RU (e.g., RU1) and/or the SS Allocation subfield may indicate a first spatial stream allocation. The second uplink resource allocation may be implicitly signaled by the Multiple Resource Allocation subfield. For example, a value of 1 for the Multiple Resource Allocation subfield may indicate that an RU associated with the second uplink resource allocation is the same as the first RU associated with the first uplink resource allocation and/or that a spatial stream allocation associated with the second uplink resource allocation is the same as the first spatial stream allocation associated with the first uplink resource allocation. In another example, a value of 1 for the Multiple Resource Allocation subfield may indicate that an RU associated with the second uplink resource allocation may be determined by STA 1202 based on the first uplink resource allocation and/or an uplink resource allocation for another STA indicated in trigger frame 908.

In another embodiment, trigger frame 908 may have a format according to trigger frame 1100 described above. As such, trigger frame 908 may include multiple User Info fields for STA 1202. A first occurring User Info field among the multiple User Info fields may include a first indication associated with the first uplink resource allocation for STA 1202, and a subsequent User Info field among the multiple User Info fields for STA 1202 may include a second indication associated with the second uplink resource allocation for STA 1202.

In an embodiment, as shown in FIG. 12, AP 902 may allocate both a first uplink resource allocation and a second uplink resource allocation to STA 1202. The first uplink resource allocation may be signaled by the RU Allocation subfield and/or the SS Allocation subfield of a first User Info field of trigger frame 908, and the second uplink resource allocation may be signaled by the RU Allocation subfield and/or the SS Allocation subfield of a second User Info field of trigger frame 908. For example, the RU Allocation subfield of the first User Info field may indicate a first RU and/or the SS Allocation subfield of the first User Info field may indicate a first spatial stream allocation. The RU Allocation subfield of the second User Info field may indicate a second RU and/or the SS Allocation subfield of the second User Info field may indicate a second spatial stream allocation.

In an embodiment, the first RU and the second RU may be the same. The first spatial stream allocation and the second spatial stream allocation may be the same or different.

In an embodiment, the first uplink resource allocation and the second resource uplink allocation contained in trigger frame 908 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a TDD slot as defined in the IEEE 802.11 standard. In another embodiment, the first/second transmission interval may correspond in duration to a portion of a TDD slot as defined in the IEEE 802.11 standard.

In response to trigger frame 908, STA 1202 may transmit a frame 1206, via the first uplink resource allocation, to AP 902. In an embodiment, the first uplink resource allocation includes a first RU and/or a first spatial stream allocation. Frame 1206 may include a TB PPDU. In an embodiment, the first time resource associated with the first uplink resource allocation starts at a first time spacing from an end of transmission of trigger frame 908. In an embodiment, as shown in FIG. 12, the first time spacing equals a SIFS duration, and frame 1206 is transmitted one SIFS after transmission of trigger frame 908.

In an embodiment, trigger frame 908 may further include a third indication associated with a third uplink resource allocation for STA 1204. The third indication may be carried by an RU Allocation subfield and/or an SS Allocation subfield of a User Info field for STA 1204 in trigger frame 908. In an embodiment, as shown in FIG. 12, the third uplink resource allocation may be associated with a same time resource as the first uplink resource allocation allocated to STA 1202. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 1202. The third uplink resource allocation may be associated with a different frequency resource and/or a different spatial resource than the second uplink resource allocation.

In response to trigger frame 908, STA 1204 may transmit a frame 1208, via the third uplink resource allocation, to AP 902. Frame 1208 may include a TB PPDU. In an embodiment, the time resource associated with the third resource allocation starts at a third time spacing from an end of transmission of trigger frame 908. In an embodiment, as shown in FIG. 12, the third time spacing equals a SIFS duration, and frame 1208 is transmitted one SIFS after transmission of trigger frame 908.

In an embodiment, AP 902 may transmit a frame 1210 after receiving frames 1206 and 1208 from STAs 1202 and 1204 respectively. Frame 1210 may include a BlockAck (BA) frame or a multi-STA BA frame. In an embodiment, frame 1210 may be transmitted one SIFS after reception of frames 1206 and 1208 by AP 902.

In an embodiment, upon receiving frame 1210 from AP 902, STA 1202 may transmit a frame 1212, via the second uplink resource allocation, to AP 902. Frame 1212 may include a TB PPDU. In an embodiment, frame 1212 may be a re-transmission of frame 1206. Re-transmission of frame 1206 using a different time resource may increase time-diversity gain.

In an embodiment, the second uplink resource allocation includes a second RU that is equal to the first RU associated with the first uplink resource allocation and/or a second spatial stream allocation that is equal to the first spatial stream allocation associated with the first uplink resource allocation. As such, frame 1212 may be transmitted via the same RU and/or via the same spatial stream allocation as frame 1206 transmitted in response to trigger frame 908. When frame 1212 is a re-transmission of frame 1206, re-using the same RU and/or the same spatial stream allocation for frame 1212 allows AP 902 to combine frames 1206 and 1212 (e.g., using maximum-ratio combining), thereby increasing the effective signal-to-noise ratio of the transmission. Additionally, this re-use of RU and/or spatial stream allocation may result in less transmission/re-transmission complexity at STA 1202.

In an embodiment, the second time resource associated with the second uplink resource allocation starts at a second time spacing from an end of transmission of frame 1210 transmitted by AP 902 in response to frames 1206 and 1208. In an embodiment, as shown in FIG. 12, the second time spacing equals a SIFS duration, and frame 1212 is transmitted one SIFS after reception of frame 1210 by STA 1202.

In an embodiment, in response to frame 1212, AP 902 may transmit a frame 1214 to STA 1202. Frame 1214 may be a BA frame acknowledging frame 1212.

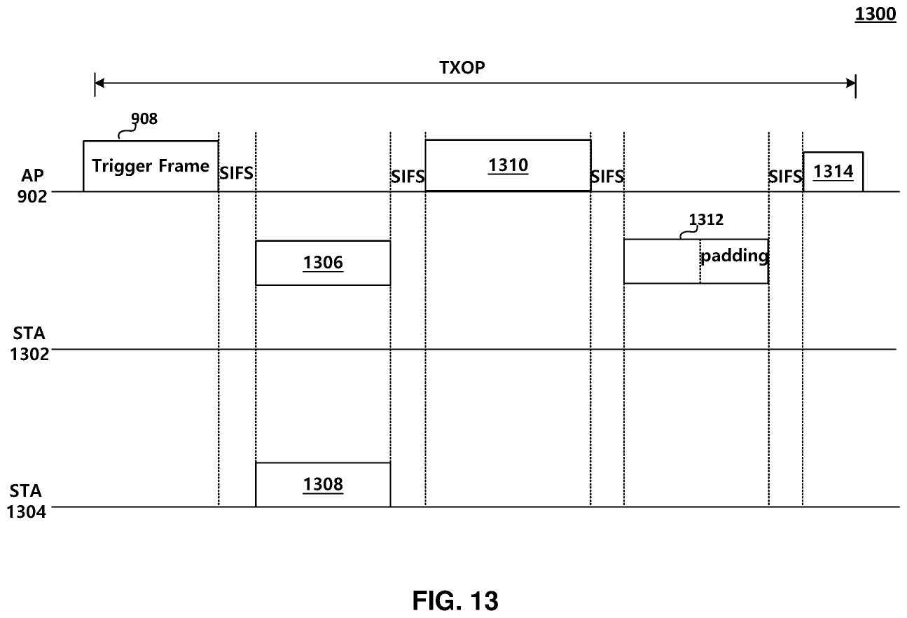

FIG. 13 illustrates an example of uplink transmission in response to a trigger frame according to an embodiment. Example 1300 is provided for the purpose of illustration only and is not limiting of embodiments of the present disclosure. As shown in FIG. 13, example 1300 includes an AP 902, a STA 1302, and a STA 1304. In an example, STAs 1302 and 1304 may be associated with AP 902.

In an example, AP 902 may obtain a TXOP and transmit a trigger frame 908 to STAs 1302 and 1304. Trigger frame 908 may solicit one or more TB PPDU from one or more of STAs 1302 and 1304.

In an embodiment, trigger frame 908 includes a first indication associated with a first uplink resource allocation for the STA 1302; and a second indication associated with a second uplink resource allocation for STA 1302. In an embodiment, an uplink resource allocation may include a frequency resource and/or spatial resource.

In an embodiment, trigger frame 908 may have a format according to trigger frame 1000 described above. As such, the first indication associated with the first uplink resource allocation for STA 1302 may be carried by an RU Allocation subfield and/or an SS Allocation subfield of a User Info field of trigger frame 908. The second indication associated with the second uplink resource allocation for STA 1302 may be carried in a Multiple Resource Allocation subfield of trigger frame 908.

In an embodiment, as shown in FIG. 13, AP 902 may allocate both a first uplink resource allocation and a second uplink resource allocation to STA 1302. The first uplink resource allocation may be signaled by the RU Allocation subfield and/or the SS Allocation subfield. For example, the RU Allocation subfield may indicate a first RU and/or the SS Allocation subfield may indicate a first spatial stream allocation. The second uplink resource allocation may be implicitly signaled by the Multiple Resource Allocation subfield. For example, a value of 1 for the Multiple Resource Allocation subfield may indicate that an RU associated with the second uplink resource allocation is the same as the first RU associated with the first uplink resource allocation and/or that a spatial stream allocation associated with the second uplink resource allocation is the same as the first spatial stream allocation associated with the first uplink resource allocation. In another example, a value of 1 for the Multiple Resource Allocation subfield may indicate that an RU associated with the second uplink resource allocation may be determined by STA 1302 based on the first uplink resource allocation and/or an uplink resource allocation for another STA indicated in trigger frame 908.

In another embodiment, trigger frame 908 may have a format according to trigger frame 1100 described above. As such, trigger frame 908 may include multiple User Info fields for STA 1302. A first occurring User Info field among the multiple User Info fields may include a first indication associated with the first uplink resource allocation for STA 1302, and a subsequent User Info field among the multiple User Info fields for STA 1302 may include a second indication associated with the second uplink resource allocation for STA 1302. For example, the RU Allocation subfield of the first User Info field may indicate a first RU and/or the SS Allocation subfield of the first User Info field may indicate a first spatial stream allocation. The RU Allocation subfield of the subsequent User Info field may indicate a second RU and/or the SS Allocation subfield of the second User Info field may indicate a second spatial stream allocation. In an embodiment, the first RU and the second RU may be the same. The first spatial stream allocation and the second spatial stream allocation may be the same or different.

In an embodiment, the first uplink resource allocation and the second resource uplink allocation contained in trigger frame 908 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a TDD slot as defined in the IEEE 802.11 standard. In another embodiment, the first/second transmission interval may correspond in duration to a portion of a TDD slot as defined in the IEEE 802.11 standard.

In response to trigger frame 908, STA 1302 may transmit a frame 1306, via the first uplink resource allocation, to AP 902. In an embodiment, the first uplink resource allocation includes a first RU and/or a first spatial stream allocation. Frame 1306 may include a TB PPDU. In an embodiment, the first time resource associated with the first uplink resource allocation starts at a first time spacing from an end of transmission of trigger frame 908. In an embodiment, as shown in FIG. 13, the first time spacing equals a SIFS duration, and frame 1306 is transmitted one SIFS after transmission of trigger frame 908.

In an embodiment, trigger frame 908 may further include a third indication associated with a third uplink resource allocation for STA 1304. The third indication may be carried by an RU Allocation subfield and/or an SS Allocation subfield of a User Info field for STA 1304 in trigger frame 908. In an embodiment, as shown in FIG. 13, the third uplink resource allocation may be associated with a same time resource as the first uplink resource allocation allocated to STA 1302. The third uplink resource allocation may be associated with a different frequency resource (e.g., RU2) and/or a different spatial resource than the first uplink resource allocation. In another embodiment, the third uplink resource allocation may be associated with a same time resource as the second uplink resource allocation allocated to STA 1302. The third uplink resource allocation may be associated with a different frequency resource and/or a different spatial resource than the second uplink resource allocation.

In response to trigger frame 908, STA 1304 may transmit a frame 1308, via the third uplink resource allocation, to AP 902. Frame 1208 may include a TB PPDU. In an embodiment, the time resource associated with the third resource allocation starts at a third time spacing from an end of transmission of trigger frame 908. In an embodiment, as shown in FIG. 13, the third time spacing equals a SIFS duration, and frame 1308 is transmitted one SIFS after transmission of trigger frame 908.

In an embodiment, AP 902 may transmit a frame 1310 after receiving frames 1306 and 1308 from STAs 1302 and 1304 respectively. Frame 1310 may include a BlockAck (BA) frame or a multi-STA BA frame. In an embodiment, frame 1310 may be transmitted one SIFS after reception of frames 1306 and 1308 by AP 902.

In an embodiment, upon receiving frame 1310 from AP 902, STA 1302 may transmit a frame 1312, via the second uplink resource allocation, to AP 902. In an embodiment, frame 1312 may be a re-transmission of frame 1306. Re-transmission of frame 1306 using a different time resource may increase time-diversity gain.

In an embodiment, trigger frame 908 may have a format according to trigger frame 1000 described above and may allocate both a first uplink resource allocation and a second uplink resource allocation to STA 1302. The first uplink resource allocation may be signaled by the RU Allocation subfield and/or the SS Allocation subfield of a first User Info field of trigger frame 908 associated with STA 1302. For example, the RU Allocation subfield may indicate a first RU (e.g., RU1) and/or the SS Allocation subfield may indicate a first spatial stream allocation (e.g., STR1). The second uplink resource allocation may be implicitly signaled by a Multiple Resource Allocation subfield of the first User Info field being set to 1 as described above.

Additionally, trigger frame 908 may allocate a third resource allocation to STA 1304. The third uplink resource allocation may be signaled by the RU Allocation subfield and/or the SS Allocation subfield of a second User Info field of trigger frame 908 associated with STA 1304. For example, the RU Allocation subfield may indicate a second RU (e.g., RU2) and/or the SS Allocation subfield may indicate a second spatial stream allocation (e.g., STR2). A Multiple Resource Allocation subfield of the second User Info field may be set to 0, to indicate that no subsequent uplink resource allocation is being allocated to STA 1304.

In an embodiment, STA 1302 may determine based on the second User Info field associated with STA 1304 (and particularly based on the Multiple Resource Allocation subfield) that STA 1304 is not being allocated a subsequent uplink resource allocation for transmission following frame 1310. Based on this determination, STA 1302 may determine that it may transmit frame 1312 on either or both: the RU (e.g., RU1) and spatial stream allocation (e.g., STR1) associated with the first uplink resource allocation allocated to STA 1302 and the RU (e.g., RU2) and spatial stream allocation (e.g., STR2) associated with the third uplink resource allocation allocated to STA 1304.

In an embodiment, STA 1302 may use the same frequency resource (e.g., RU1) and spatial stream allocation (e.g., STR1) associated with the first uplink resource allocation allocated to STA 1302 to transmit frame 1312. As such, a PSDU associated with frame 1312 may be made shorter than a PSDU associated with frame 1306. For example, the PSDU associated with frame 1312 may omit certain fields used for training purposes by the AP as frame 1312 uses the same frequency resource and spatial stream allocation as frame 1306. This results in latency gain from the AP perspective. In an embodiment, padding bits may be inserted into frame 1312 to ensure equal frame (PPDU) length between frame 1306 and frame 1312.

In an embodiment, the second time resource associated with the second uplink resource allocation starts at a second time spacing from an end of transmission of frame 1310 transmitted by AP 902 in response to frames 1306 and 1308. In an embodiment, as shown in FIG. 13, the second time spacing equals a SIFS duration, and frame 1312 is transmitted one SIFS after reception of frame 1310 by STA 1302.

In an embodiment, in response to frame 1312, AP 902 may transmit a frame 1314 to STA 1302. Frame 1314 may be a BA frame acknowledging frame 1312.

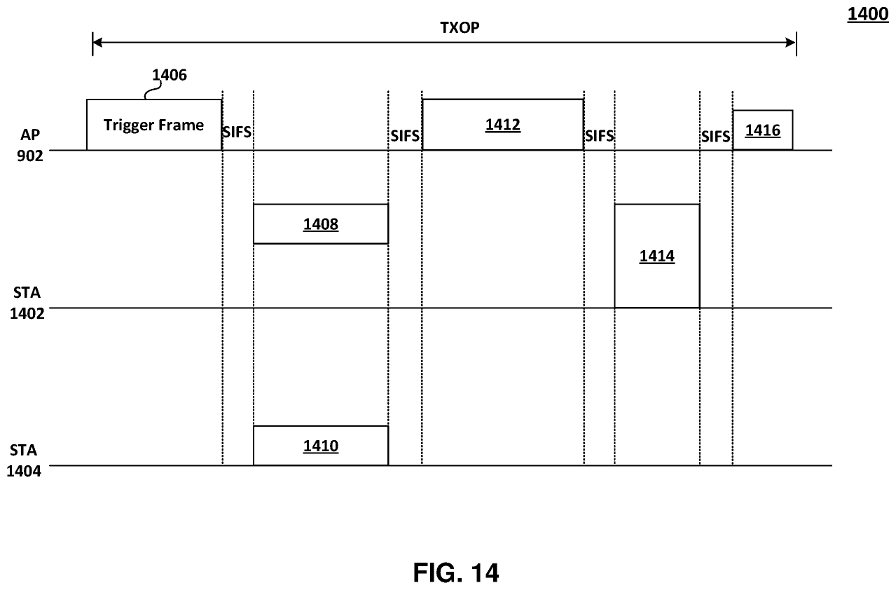

FIG. 14 illustrates an example of uplink transmission in response to a trigger frame according to an embodiment. Example 1400 is provided for the purpose of illustration only and is not limiting of embodiments of the present disclosure. As shown in FIG. 14, example 1400 includes an AP 902, a STA 1402, and a STA 1404. In an example, STAs 1402 and 1404 may be associated with AP 902.

In an example, AP 902 may obtain a TXOP and transmit a trigger frame 1406 to STAs 1402 and 1404. Trigger frame 1406 may solicit one or more TB PPDU from one or more of STAs 1402 and 1404.

In an embodiment, trigger frame 1406 includes a first indication associated with a first uplink resource allocation for the STA 1402; and a second indication associated with a second uplink resource allocation for STA 1402. In an embodiment, an uplink resource allocation may include a frequency resource and/or spatial resource.

In an embodiment, trigger frame 1406 may have a format according to trigger frame 1000 described above. As such, the first indication associated with the first uplink resource allocation for STA 1402 may be carried by an RU Allocation subfield and/or an SS Allocation subfield of a User Info field of trigger frame 1406. The second indication associated with the second uplink resource allocation for STA 1402 may be carried in a Multiple Resource Allocation subfield of trigger frame 1406.

In an embodiment, as shown in FIG. 14, AP 902 may allocate both a first uplink resource allocation and a second uplink resource allocation to STA 1402. The first uplink resource allocation may be signaled by the RU Allocation subfield and/or the SS Allocation subfield. For example, the RU Allocation subfield may indicate a first RU and/or the SS Allocation subfield may indicate a first spatial stream allocation. The second uplink resource allocation may be implicitly signaled by the Multiple Resource Allocation subfield. For example, a value of 1 for the Multiple Resource Allocation subfield may indicate that an RU associated with the second uplink resource allocation is the same as the first RU associated with the first uplink resource allocation and/or that a spatial stream allocation associated with the second uplink resource allocation is the same as the first spatial stream allocation associated with the first uplink resource allocation. In another example, a value of 1 for the Multiple Resource Allocation subfield may indicate that an RU associated with the second uplink resource allocation may be determined by STA 1302 based on the first uplink resource allocation and/or an uplink resource allocation for another STA indicated in trigger frame 1406.

In another embodiment, trigger frame 1406 may have a format according to trigger frame 1100 described above. As such, trigger frame 1406 may include multiple User Info fields for STA 1402. A first occurring User Info field among the multiple User Info fields may include a first indication associated with the first uplink resource allocation for STA 1402, and a subsequent User Info field among the multiple User Info fields for STA 1402 may include a second indication associated with the second uplink resource allocation for STA 1402. For example, the RU Allocation subfield of the first User Info field may indicate a first RU and/or the SS Allocation subfield of the first User Info field may indicate a first spatial stream allocation. The RU Allocation subfield of the subsequent User Info field may indicate a second RU and/or the SS Allocation subfield of the second User Info field may indicate a second spatial stream allocation. In an embodiment, the first RU and the second RU may be the same. The first spatial stream allocation and the second spatial stream allocation may be the same or different.

In an embodiment, the first uplink resource allocation and the second resource uplink allocation contained in trigger frame 1406 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a TDD slot as defined in the IEEE 802.11 standard. In another embodiment, the first/second transmission interval may correspond in duration to a portion of a TDD slot as defined in the IEEE 802.11 standard.

In response to trigger frame 1406, STA 1402 may transmit a frame 1408, via the first uplink resource allocation, to AP 902. In an embodiment, the first uplink resource allocation includes a first RU and/or a first spatial resource allocation. Frame 1408 may include a TB PPDU. In an embodiment, the first time resource associated with the first uplink resource allocation starts at a first time spacing from an end of transmission of trigger frame 1406. In an embodiment, as shown in FIG. 14, the first time spacing equals a SIFS duration, and frame 1408 is transmitted one SIFS after transmission of trigger frame 1406.

In an embodiment, trigger frame 1406 may further include a third indication associated with a third uplink resource allocation for STA 1404. The third indication may be carried by an RU Allocation subfield and/or an SS Allocation subfield of a User Info field for STA 1404 in trigger frame 1406. In an embodiment, as shown in FIG. 14, the third uplink resource allocation may be associated with a same time resource as the first uplink resource allocation allocated to STA 1402. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 1402. The third uplink resource allocation may be associated with a different frequency resource and/or a different spatial resource than the second uplink resource allocation.

In response to trigger frame 1406, STA 1404 may transmit a frame 1410, via the third uplink resource allocation, to AP 902. Frame 1410 may include a TB PPDU. In an embodiment, the time resource associated with the third resource allocation starts at a third time spacing from an end of transmission of trigger frame 1406. In an embodiment, as shown in FIG. 14, the third time spacing equals a SIFS duration, and frame 1410 is transmitted one SIFS after transmission of trigger frame 1406.

In an embodiment, AP 902 may transmit a frame 1412 after receiving frames 1408 and 1412 from STAs 1402 and 1404 respectively. Frame 1412 may include a BlockAck (BA) frame or a multi-STA BA frame. In an embodiment, frame 1412 may be transmitted one SIFS after reception of frames 1408 and 1410 by AP 902.

In an embodiment, upon receiving frame 1412 from AP 902, STA 1402 may transmit a frame 1414, via the second uplink resource allocation, to AP 902. Frame 1414 may include a TB PPDU. In an embodiment, frame 1414 may be a re-transmission of frame 1408. Re-transmission of frame 1408 using a different time resource may increase time-diversity gain.

In an embodiment, trigger frame 1406 may have a format according to trigger frame 1000 described above and may allocate both a first uplink resource allocation and a second uplink resource allocation to STA 1402. The first uplink resource allocation may be signaled by the RU Allocation subfield and/or the SS Allocation subfield of a first User Info field of trigger frame 1406 associated with STA 1402. For example, the RU Allocation subfield may indicate a first RU (e.g., RU1) and/or the SS Allocation subfield may indicate a first spatial stream allocation (e.g., STR1). The second uplink resource allocation may be implicitly signaled by a Multiple Resource Allocation subfield of the first User Info field being set to 1 as described above.

Additionally, trigger frame 1406 may allocate a third resource allocation to STA 1404. The third uplink resource allocation may be signaled by the RU Allocation subfield and/or the SS Allocation subfield of a second User Info field of trigger frame 1406 associated with STA 1404. For example, the RU Allocation subfield may indicate a second RU (e.g., RU2) and/or the SS Allocation subfield may indicate a second spatial stream allocation (e.g., STR2). A Multiple Resource Allocation subfield of the second User Info field may be set to 0, to indicate that no subsequent uplink resource allocation is being allocated to STA 1404.

In an embodiment, STA 1402 may determine based on the second User Info field associated with STA 1404 (and particularly based on the Multiple Resource Allocation subfield) that STA 1404 is not being allocated a subsequent uplink resource allocation for transmission following frame 1414. Based on this determination, STA 1402 may determine that it may transmit frame 1414 on either or both of: the RU (e.g., RU1) and spatial stream allocation (e.g., STR1) associated with the first uplink resource allocation allocated to STA 1402 and the RU (e.g., RU2) and spatial stream allocation (e.g., STR2) associated with the third uplink resource allocation allocated to STA 1404. STA 1402 may thus determine the second uplink resource allocation based on the first uplink resource allocation and/or the third uplink resource allocation.

In an embodiment, STA 1402 may use both the frequency resource (e.g., RU1) and spatial stream allocation (e.g., STR1) associated with the first uplink resource allocation and the frequency resource (e.g., RU2) and spatial stream allocation (e.g., STR2) associated with the third uplink resource allocation to transmit frame 1414. As such, a transmission time of frame 1414 may be made shorter than (e.g., approximately half) a transmission time of frame 1408. This results in improved transmission latency.

In an embodiment, the second time resource associated with the second uplink resource allocation starts at a second time spacing from an end of transmission of frame 1412 transmitted by AP 902 in response to frames 1408 and 1410. In an embodiment, as shown in FIG. 14, the second time spacing equals a SIFS duration, and frame 1414 is transmitted one SIFS after reception of frame 1412 by STA 1402.

In an embodiment, in response to frame 1414, AP 902 may transmit a frame 1416 to STA 1402. Frame 1416 may be a BA frame acknowledging frame 1414.

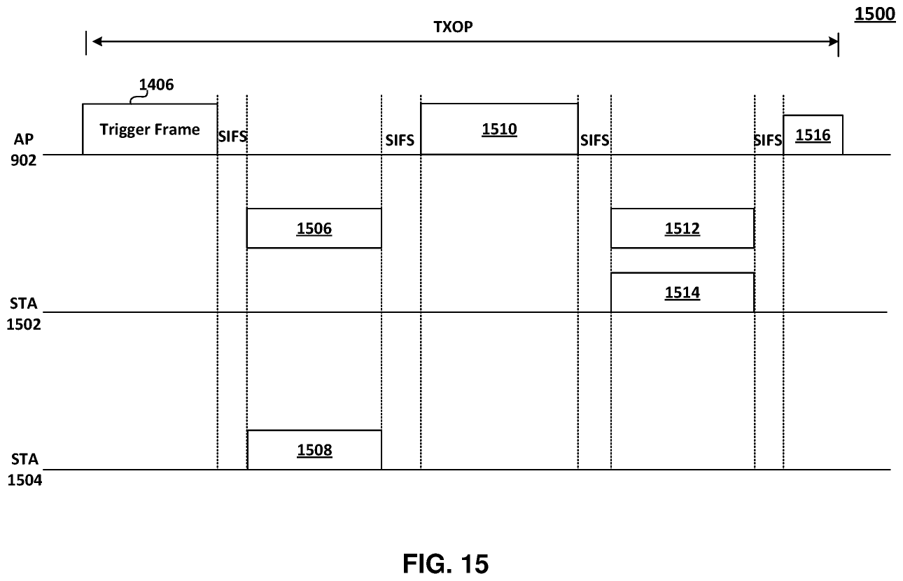

FIG. 15 illustrates an example of uplink transmission in response to a trigger frame according to an embodiment. Example 1500 is provided for the purpose of illustration only and is not limiting of embodiments of the present disclosure. As shown in FIG. 15, example 1500 includes an AP 902, a STA 1502, and a STA 1504. In an example, STAs 1502 and 1504 may be associated with AP 902.

In an example, AP 902 may obtain a TXOP and transmit a trigger frame 1406 to STAs 1502 and 1504. Trigger frame 1406 may solicit one or more TB PPDU from one or more of STAs 1502 and 1504.

In an embodiment, trigger frame 1406 includes a first indication associated with a first uplink resource allocation for the STA 1502; and a second indication associated with a second uplink resource allocation for STA 1502. In an embodiment, an uplink resource allocation may include a frequency resource and/or spatial resource.

In an embodiment, trigger frame 1406 may have a format according to trigger frame 1000 described above. As such, the first indication associated with the first uplink resource allocation for STA 1502 may be carried by an RU Allocation subfield and/or an SS Allocation subfield of a User Info field of trigger frame 1406. The second indication associated with the second uplink resource allocation for STA 1502 may be carried in a Multiple Resource Allocation subfield of trigger frame 1406.

In an embodiment, as shown in FIG. 15, AP 902 may allocate both a first uplink resource allocation and a second uplink resource allocation to STA 1502. The first uplink resource allocation may be signaled by the RU Allocation subfield and/or the SS Allocation subfield. For example, the RU Allocation subfield may indicate a first RU and/or the SS Allocation subfield may indicate a first spatial stream allocation. The second uplink resource allocation may be implicitly signaled by the Multiple Resource Allocation subfield. For example, a value of 1 for the Multiple Resource Allocation subfield may indicate that an RU associated with the second uplink resource allocation is the same as the first RU associated with the first uplink resource allocation and/or that a spatial stream allocation associated with the second uplink resource allocation is the same as the first spatial stream allocation associated with the first uplink resource allocation. In another example, a value of 1 for the Multiple Resource Allocation subfield may indicate that an RU associated with the second uplink resource allocation may be determined by STA 1502 based on the first uplink resource allocation and/or an uplink resource allocation for another STA indicated in trigger frame 1406.

In another embodiment, trigger frame 1406 may have a format according to trigger frame 1100 described above. As such, trigger frame 1406 may include multiple User Info fields for STA 1502. A first occurring User Info field among the multiple User Info fields may include a first indication associated with the first uplink resource allocation for STA 1502, and a subsequent User Info field among the multiple User Info fields for STA 1502 may include a second indication associated with the second uplink resource allocation for STA 1502. For example, the RU Allocation subfield of the first User Info field may indicate a first RU and/or the SS Allocation subfield of the first User Info field may indicate a first spatial stream allocation. The RU Allocation subfield of the subsequent User Info field may indicate a second RU and/or the SS Allocation subfield of the second User Info field may indicate a second spatial stream allocation. In an embodiment, the first RU and the second RU may be the same. The first spatial stream allocation and the second spatial stream allocation may be the same or different.

In an embodiment, the first uplink resource allocation and the second resource uplink allocation contained in trigger frame 1406 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a TDD slot as defined in the IEEE 802.11 standard. In another embodiment, the first/second transmission interval may correspond in duration to a portion of a TDD slot as defined in the IEEE 802.11 standard.

In response to trigger frame 1406, STA 1502 may transmit a frame 1506, via the first uplink resource allocation, to AP 902. In an embodiment, the first uplink resource allocation includes a first RU and/or a first spatial resource allocation. Frame 1506 may include a TB PPDU. In an embodiment, the first time resource associated with the first uplink resource allocation starts at a first time spacing from an end of transmission of trigger frame 1406. In an embodiment, as shown in FIG. 15, the first time spacing equals a SIFS duration, and frame 1506 is transmitted one SIFS after transmission of trigger frame 1406.

In an embodiment, trigger frame 1406 may further include a third indication associated with a third uplink resource allocation for STA 1504. The third indication may be carried by an RU Allocation subfield and/or an SS Allocation subfield of a User Info field for STA 1504 in trigger frame 1406. In an embodiment, as shown in FIG. 15, the third uplink resource allocation may be associated with a same time resource as the first uplink resource allocation allocated to STA 1502. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 1502. The third uplink resource allocation may be associated with a different frequency resource and/or a different spatial resource than the second uplink resource allocation.

In response to trigger frame 1406, STA 1504 may transmit a frame 1508, via the third uplink resource allocation, to AP 902. Frame 1508 may include a TB PPDU. In an embodiment, the time resource associated with the third resource allocation starts at a third time spacing from an end of transmission of trigger frame 1406. In an embodiment, as shown in FIG. 15, the third time spacing equals a SIFS duration, and frame 1508 is transmitted one SIFS after transmission of trigger frame 1406.

In an embodiment, AP 902 may transmit a frame 1510 after receiving frames 1506 and 1508 from STAs 1502 and 1504 respectively. Frame 1510 may include a BlockAck (BA) frame or a multi-STA BA frame. In an embodiment, frame 1510 may be transmitted one SIFS after reception of frames 1506 and 1508 by AP 902.

In an embodiment, upon receiving frame 1510 from AP 902, STA 1502 may transmit frames 1512 and 1514, via the second uplink resource allocation, to AP 902. Frame 1512 or 1514 may include a TB PPDU. In an embodiment, frame 1512 and/or 1514 may be a re-transmission of frame 1506. Re-transmission of frame 1506 using a different time resource may increase time-diversity gain.

In an embodiment, trigger frame 1406 may have a format according to trigger frame 1000 described above and may allocate both a first uplink resource allocation and a second uplink resource allocation to STA 1502. The first uplink resource allocation may be signaled by the RU Allocation subfield and/or the SS Allocation subfield of a first User Info field of trigger frame 1406 associated with STA 1502. For example, the RU Allocation subfield may indicate a first RU (e.g., RU1) and/or the SS Allocation subfield may indicate a first spatial stream allocation (e.g., STR1). The second uplink resource allocation may be implicitly signaled by a Multiple Resource Allocation subfield of the first User Info field being set to 1 as described above.

Additionally, trigger frame 1406 may allocate a third resource allocation to STA 1504. The third uplink resource allocation may be signaled by the RU Allocation subfield and/or the SS Allocation subfield of a second User Info field of trigger frame 1406 associated with STA 1504. For example, the RU Allocation subfield may indicate a second RU (e.g., RU2) and/or the SS Allocation subfield may indicate a second spatial stream allocation (e.g., STR2). A Multiple Resource Allocation subfield of the second User Info field may be set to 0, to indicate that no subsequent uplink resource allocation is being allocated to STA 1504.

In an embodiment, STA 1502 may determine based on the second User Info field associated with STA 1504 (and particularly based on the Multiple Resource Allocation subfield) that STA 1504 is not being allocated a subsequent uplink resource allocation for transmission following frame 1510. Based on this determination, STA 1502 may determine that it may transmit frames 1512 and 1514 using the RU (e.g., RU1) and spatial stream allocation (e.g., STR1) associated with the first uplink resource allocation and the RU (e.g., RU2) and spatial stream allocation (e.g., STR2) associated with the third uplink resource allocation. STA 1402 may thus determine the second uplink resource allocation based on the first uplink resource allocation and/or the third uplink resource allocation.

In an embodiment, STA 1402 may transmit frame 1512 using the frequency resource (e.g., RU1) and spatial stream allocation (e.g., STR1) associated with the first uplink resource allocation allocated to STA 1502 and may transmit frame 1514 using the frequency resource (e.g., RU2) and spatial stream allocation (e.g., STR2) associated with the third uplink resource allocation allocated to STA 1504. In an embodiment, frames 1512 and 1514 may be duplicate frames, which results in increased transmission reliability. In another embodiment, frames 1512 and 1514 may be different frames, allowing more data to be transmitted per uplink resource allocation.

In an embodiment, the second time resource associated with the second uplink resource allocation starts at a second time spacing from an end of transmission of frame 1510 transmitted by AP 902 in response to frames 1506 and 1508. In an embodiment, as shown in FIG. 15, the second time spacing equals a SIFS duration, and frames 1512 and 1514 are transmitted one SIFS after reception of frame 1510 by STA 1502. In an embodiment, uplink resource allocation of frame 1512 and frame 1514 may provide reliable transmission for the STA 1502. The information in frame 1512 is duplicated into frame 1514.

In an embodiment, in response to frame 1512/1514, AP 902 may transmit a frame 1516 to STA 1502. Frame 1516 may be a BA frame acknowledging frame 1512 and 1514.

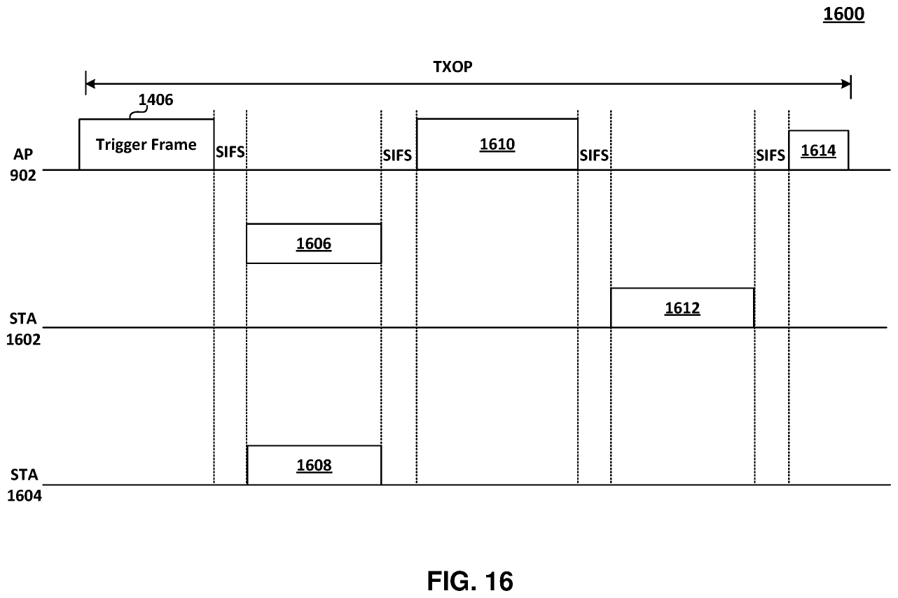

FIG. 16 illustrates an example of uplink transmission in response to a trigger frame according to an embodiment. Example 1600 is provided for the purpose of illustration only and is not limiting of embodiments of the present disclosure. As shown in FIG. 16, example 1600 includes an AP 902, a STA 1602, and a STA 1604. In an example, STAs 1602 and 1604 may be associated with AP 902.

In an example, AP 902 may obtain a TXOP and transmit a trigger frame 1406 to STAs 1602 and 1604. Trigger frame 1406 may solicit one or more TB PPDU from one or more of STAs 1602 and 1604.

In an embodiment, trigger frame 1406 includes a first indication associated with a first uplink resource allocation for the STA 1602; and a second indication associated with a second uplink resource allocation for STA 1602. In an embodiment, an uplink resource allocation may include a frequency resource and/or spatial resource.

In an embodiment, trigger frame 1406 may have a format according to trigger frame 1000 described above. As such, the first indication associated with the first uplink resource allocation for STA 1602 may be carried by an RU Allocation subfield and/or an SS Allocation subfield of a User Info field of trigger frame 1406. The second indication associated with the second uplink resource allocation for STA 1602 may be carried in a Multiple Resource Allocation subfield of trigger frame 1406.

In an embodiment, as shown in FIG. 16, AP 902 may allocate both a first uplink resource allocation and a second uplink resource allocation to STA 1602. The first uplink resource allocation may be signaled by the RU Allocation subfield and/or the SS Allocation subfield. For example, the RU Allocation subfield may indicate a first RU and/or the SS Allocation subfield may indicate a first spatial stream allocation. The second uplink resource allocation may be implicitly signaled by the Multiple Resource Allocation subfield. For example, a value of 1 for the Multiple Resource Allocation subfield may indicate that an RU associated with the second uplink resource allocation is the same as the first RU associated with the first uplink resource allocation and/or that a spatial stream allocation associated with the second uplink resource allocation is the same as the first spatial stream allocation associated with the first uplink resource allocation. In another example, a value of 1 for the Multiple Resource Allocation subfield may indicate that an RU associated with the second uplink resource allocation may be determined by STA 1602 based on the first uplink resource allocation and/or an uplink resource allocation for another STA indicated in trigger frame 1406.

In another embodiment, trigger frame 1406 may have a format according to trigger frame 1100 described above. As such, trigger frame 1406 may include multiple User Info fields for STA 1602. A first occurring User Info field among the multiple User Info fields may include a first indication associated with the first uplink resource allocation for STA 1602, and a subsequent User Info field among the multiple User Info fields for STA 1602 may include a second indication associated with the second uplink resource allocation for STA 1602. For example, the RU Allocation subfield of the first User Info field may indicate a first RU and/or the SS Allocation subfield of the first User Info field may indicate a first spatial stream allocation. The RU Allocation subfield of the subsequent User Info field may indicate a second RU and/or the SS Allocation subfield of the second User Info field may indicate a second spatial stream allocation. In an embodiment, the first RU and the second RU may be the same. The first spatial stream allocation and the second spatial stream allocation may be the same or different.

In an embodiment, the first uplink resource allocation and the second resource uplink allocation contained in trigger frame 1406 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a TDD slot as defined in the IEEE 802.11 standard. In another embodiment, the first/second transmission interval may correspond in duration to a portion of a TDD slot as defined in the IEEE 802.11 standard.

In response to trigger frame 1406, STA 1602 may transmit a frame 1606, via the first uplink resource allocation, to AP 902. In an embodiment, the first uplink resource allocation includes a first RU and/or a first spatial resource allocation. Frame 1606 may include a TB PPDU. In an embodiment, the first time resource associated with the first uplink resource allocation starts at a first time spacing from an end of transmission of trigger frame 1406. In an embodiment, as shown in FIG. 16, the first time spacing equals a SIFS duration, and frame 1606 is transmitted one SIFS after transmission of trigger frame 1406.

In an embodiment, trigger frame 1406 may further include a third indication associated with a third uplink resource allocation for STA 1604. The third indication may be carried by an RU Allocation subfield and/or an SS Allocation subfield of a User Info field for STA 1504 in trigger frame 1406. In an embodiment, as shown in FIG. 16, the third uplink resource allocation may be associated with a same time resource as the first uplink resource allocation allocated to STA 1602. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 1602. The third uplink resource allocation may be associated with a different frequency resource and/or a different spatial resource than the second uplink resource allocation.

In response to trigger frame 1406, STA 1604 may transmit a frame 1608, via the third uplink resource allocation, to AP 902. Frame 1608 may include a TB PPDU. In an embodiment, the time resource associated with the third resource allocation starts at a third time spacing from an end of transmission of trigger frame 1406. In an embodiment, as shown in FIG. 16, the third time spacing equals a SIFS duration, and frame 1608 is transmitted one SIFS after transmission of trigger frame 1406.

In an embodiment, AP 902 may transmit a frame 1610 after receiving frames 1606 and 1608 from STAs 1602 and 1604 respectively. Frame 1610 may include a BlockAck (BA) frame or a multi-STA BA frame. In an embodiment, frame 1510 may be transmitted one SIFS after reception of frames 1606 and 1608 by AP 902.

In an embodiment, upon receiving frame 1610 from AP 902, STA 1602 may transmit a frame 1612, via the second uplink resource allocation, to AP 902. Frame 1612 may include a TB PPDU. In an embodiment, frame 1512 and/or 1514 may be a re-transmission of frame 1506. Re-transmission of frame 1506 using a different time resource may increase time-diversity gain.

In an embodiment, trigger frame 1406 may have a format according to trigger frame 1000 described above and may allocate both a first uplink resource allocation and a second uplink resource allocation to STA 1602. The first uplink resource allocation may be signaled by the RU Allocation subfield and/or the SS Allocation subfield of a first User Info field of trigger frame 1406 associated with STA 1602. For example, the RU Allocation subfield may indicate a first RU (e.g., RU1) and/or the SS Allocation subfield may indicate a first spatial stream allocation (e.g., STR1). The second uplink resource allocation may be implicitly signaled by a Multiple Resource Allocation subfield of the first User Info field being set to 1 as described above.

Additionally, trigger frame 1406 may allocate a third resource allocation to STA 1604. The third uplink resource allocation may be signaled by the RU Allocation subfield and/or the SS Allocation subfield of a second User Info field of trigger frame 1406 associated with STA 1604. For example, the RU Allocation subfield may indicate a second RU (e.g., RU2) and/or the SS Allocation subfield may indicate a second spatial stream allocation (e.g., STR2). A Multiple Resource Allocation subfield of the second User Info field may be set to 0, to indicate that no subsequent uplink resource allocation is being allocated to STA 1604.

In an embodiment, STA 1602 may determine based on the second User Info field associated with STA 1604 (and particularly based on the Multiple Resource Allocation subfield) that STA 1604 is not being allocated a subsequent uplink resource allocation for transmission following frame 1610. Based on this determination, STA 1602 may determine that it may transmit frame 1612 on either or both: the RU (e.g., RU1) and spatial stream allocation (e.g., STR1) associated with the first uplink resource allocation allocated to STA 1602 and the RU (e.g., RU2) and spatial stream allocation (e.g., STR2) associated with the third uplink resource allocation allocated to STA 1604. STA 1602 may thus determine the second uplink resource allocation based on the first uplink resource allocation and/or the third uplink resource allocation.

In an embodiment, STA 1602 may transmit frame 1612 using the frequency resource (e.g., RU2) and spatial stream allocation (e.g., STR2) associated with the third uplink resource allocation allocated to STA 1604 in trigger frame 1406.

In an embodiment, the second time resource associated with the second uplink resource allocation starts at a second time spacing from an end of transmission of frame 1610 transmitted by AP 902 in response to frames 1606 and 1608. In an embodiment, as shown in FIG. 16, the second time spacing equals a SIFS duration, and frame 1612 is transmitted one SIFS after reception of frame 1610 by STA 1602. In an embodiment, different RU is allocated to frame 1606 and frame 1612 for the STA 1602.

In an embodiment, in response to frame 1612, AP 902 may transmit a frame 1614 to STA 1602. Frame 1614 may be a BA frame acknowledging frame 1612.

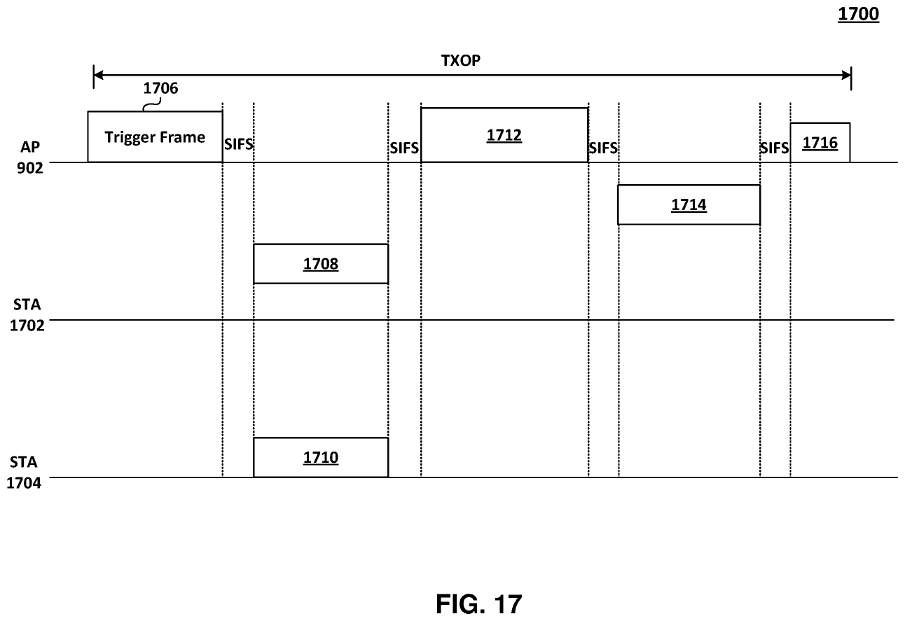

FIG. 17 illustrates an example 1700 of uplink transmission in response to a trigger frame according to an embodiment. Example 1700 is provided for the purpose of illustration only and is not limiting of embodiments of the present disclosure. As shown in FIG. 17, example 1700 includes an AP 902, a STA 1702, and a STA 1704. In an example, STAs 1702 and 1704 may be associated with AP 902.

In an example, AP 902 may obtain a TXOP and transmit a trigger frame 1706 to STAs 1702 and 1704. Trigger frame 1706 may solicit one or more trigger-based (TB) physical layer (PHY) protocol data unit (PPDU) from one or more of STAs 1702 and 1704.

In an embodiment, trigger frame 1706 includes a first indication associated with a first uplink resource allocation for the STA 1702; and a second indication associated with a second uplink resource allocation for STA 1704. In an embodiment, an uplink resource allocation may include a frequency resource and/or spatial resource.

In an embodiment, trigger frame 1706 may have a format according to trigger frame 1000 described above. As such, the first indication associated with the first uplink resource allocation for STA 1702 may be carried by an RU Allocation subfield and/or an SS Allocation subfield of a User Info field of trigger frame 1706. The second indication associated with the second uplink resource allocation for STA 1702 may be carried in a Multiple Resource Allocation subfield of trigger frame 1706.

In an embodiment, as shown in FIG. 17, AP 902 may allocate both a first uplink resource allocation and a second uplink resource allocation to STA 1702. The first uplink resource allocation may be signaled by the RU Allocation subfield and/or the SS Allocation subfield. For example, the RU Allocation subfield may indicate a first RU and/or the SS Allocation subfield may indicate a first spatial stream allocation. The second uplink resource allocation may be implicitly signaled by the Multiple Resource Allocation subfield. For example, a value of 1 for the Multiple Resource Allocation subfield may indicate that an RU associated with the second uplink resource allocation is the same as the first RU associated with the first uplink resource allocation and/or that a spatial stream allocation associated with the second uplink resource allocation is the same as the first spatial stream allocation associated with the first uplink resource allocation. In another example, a value of 1 for the Multiple Resource Allocation subfield may indicate that an RU associated with the second uplink resource allocation may be determined by STA 1702 based on the first uplink resource allocation and/or an uplink resource allocation for another STA indicated in trigger frame 1706.

In another embodiment, trigger frame 1706 may have a format according to trigger frame 1100 described above. As such, trigger frame 1706 may include multiple User Info fields for STA 1702. A first occurring User Info field among the multiple User Info fields may include a first indication associated with the first uplink resource allocation for STA 1702, and a subsequent User Info field among the multiple User Info fields for STA 1702 may include a second indication associated with the second uplink resource allocation for STA 1702. For example, the RU Allocation subfield of the first User Info field may indicate a first RU and/or the SS Allocation subfield of the first User Info field may indicate a first spatial stream allocation. The RU Allocation subfield of the subsequent User Info field may indicate a second RU and/or the SS Allocation subfield of the second User Info field may indicate a second spatial stream allocation. In an embodiment, the first RU and the second RU may be the same. The first spatial stream allocation and the second spatial stream allocation may be the same or different.

In an embodiment, the first uplink resource allocation and the second resource uplink allocation contained in trigger frame 1706 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, the first/second transmission interval may correspond in duration to a time division duplex (TDD) slot as defined in the IEEE 802.11 standard. In another embodiment, the first/second transmission interval may correspond in duration to a portion of a TDD slot as defined in the IEEE 802.11 standard.

In response to trigger frame 1706, STA 1702 may transmit a frame 1708, via the first uplink resource allocation, to AP 902. In an embodiment, the first uplink resource allocation includes a first RU and/or a first spatial resource allocation. Frame 1708 may include a TB PPDU. In an embodiment, the first time resource associated with the first uplink resource allocation starts at a first time spacing from an end of transmission of trigger frame 1706. In an embodiment, as shown in FIG. 17, the first time spacing equals a short interframe spacing (SIFS) duration, and frame 1708 is transmitted one SIFS after transmission of trigger frame 1706.

In an embodiment, trigger frame 1706 may further include a third indication associated with a third uplink resource allocation for STA 1704. The third indication may be carried by an RU Allocation subfield and/or an SS Allocation subfield of a User Info field for STA 1704 in trigger frame 1406. In an embodiment, as shown in FIG. 17, the third uplink resource allocation may be associated with a same time resource as the first uplink resource allocation allocated to STA 1702. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 1702. The third uplink resource allocation may be associated with a different frequency resource and/or a different spatial resource than the second uplink resource allocation.

In response to trigger frame 1706, STA 1704 may transmit a frame 1710, via the third uplink resource allocation, to AP 902. Frame 1710 may include a TB PPDU.

In an embodiment, the time resource associated with the third resource allocation starts at a third time spacing from an end of transmission of trigger frame 1710. In an embodiment, as shown in FIG. 17, the third time spacing equals a short interframe spacing (SIFS) duration, and frame 1710 is transmitted one SIFS after transmission of trigger frame 1706.

In an embodiment, AP 902 may transmit a frame 1712 after receiving frames 1708 and 1710 from STAs 1702 and 1704 respectively. Frame 1712 may include a BlockAck (BA) frame or a multi-STA BA frame. In an embodiment, frame 1712 may be transmitted one SIFS after reception of frames 1708 and 1710 by AP 902.

In an embodiment, upon receiving frame 1712 from AP 902, STA 1702 may transmit a frame 1714, via the second uplink resource allocation, to AP 902. Frame 1714 may include a TB PPDU. In an embodiment, frame 1714 may be a re-transmission of frame 1708. Re-transmission of frame 1708 using a different time resource may increase time-diversity gain.

In an embodiment, trigger frame 1706 may have a format according to trigger frame 1100 described above and may allocate both a first uplink resource allocation and a second uplink resource allocation to STA 1702. As such, trigger frame 1706 may include a first and a second User Info field for STA 1702. The first User Info field may include a first indication associated with the first uplink resource allocation for STA 1702, and the second User Info field may include a second indication associated with the second uplink resource allocation for STA 1702. For example, the RU Allocation subfield of the first User Info field may indicate a first RU (e.g., RU1) and/or the SS Allocation subfield of the first User Info field may indicate a first spatial stream allocation (e.g., STR1). The RU Allocation subfield of the second User Info field may indicate a second RU (e.g., RU2) and/or the SS Allocation subfield of the second User Info field may indicate a second spatial stream allocation (e.g., STR2).

Additionally, trigger frame 1706 may allocate a third resource allocation to STA 1704. The third uplink resource allocation may be signaled by the RU Allocation subfield and/or the SS Allocation subfield of a third User Info field of trigger frame 1706 associated with STA 1704. For example, the RU Allocation subfield may indicate a third RU (e.g., RU3) and/or the SS Allocation subfield may indicate a third spatial stream allocation (e.g., STR3).

In an embodiment, the second RU of the second uplink resource allocation for STA 1702 may be equal to the third RU of the third uplink resource allocation for STA 1704. The second spatial stream allocation of the second uplink resource allocation may or may not be equal to the third spatial stream allocation of the third uplink resource allocation.

In another embodiment, the first RU of the first uplink resource allocation for STA 1702 may be equal to the third RU of the third uplink resource allocation for STA 1704, and the first spatial stream allocation of the first uplink resource allocation for STA 1702 may be different than the third spatial stream allocation of the third uplink resource allocation for STA 1704. The second RU of the second uplink resource allocation for STA 1702 may be equal to the first RU (and the third RU). The second spatial stream allocation of the second uplink resource allocation for STA 1702 may be equal or different than the first spatial stream allocation (or the third spatial stream allocation).

In an embodiment, the second time resource associated with the second uplink resource allocation starts at a second time spacing from an end of transmission of frame 1712 transmitted by AP 902 in response to frames 1708 and 1710. In an embodiment, as shown in FIG. 17, the second time spacing equals a SIFS duration, and frame 1714 is transmitted one SIFS after reception of frame 1712 by STA 1702.

In an embodiment, in response to frame 1714, AP 902 may transmit a frame 1716 to STA 1702. Frame 1716 may be a BA frame acknowledging frame 1714.

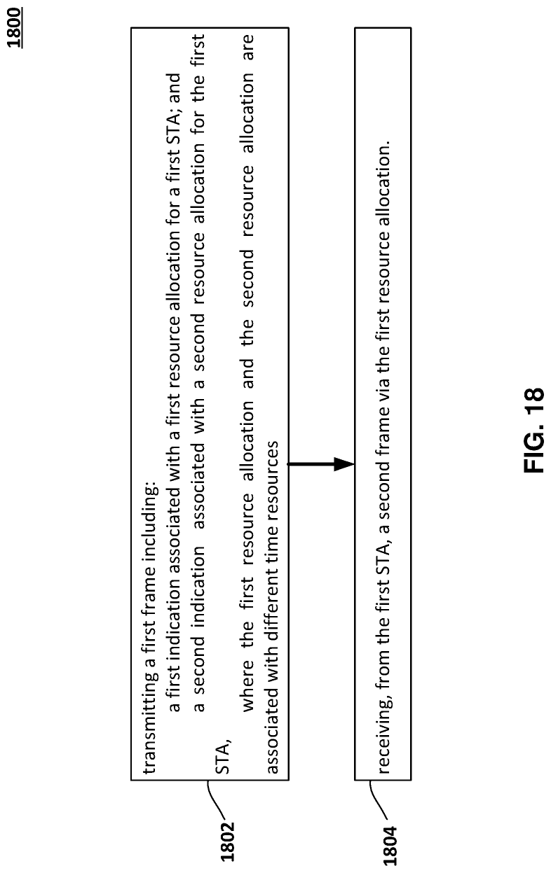

FIG. 18 illustrates an example process 1800 according to an embodiment. Example process 1800 is provided for the purpose of illustration and is not limiting of embodiments. Example process 1800 may be performed by an AP, such as AP 902.

As shown in FIG. 18, process 1800 may begin in step 1802, which includes transmitting a first frame including: a first indication associated with a first resource allocation for a first STA; and a second indication associated with a second resource allocation for the first STA. The first resource allocation and the second resource allocation may be associated with different time resources.

In an embodiment, the first indication indicates a resource associated with the first uplink resource allocation. The resource may include a frequency resource and/or a spatial resource.

In an embodiment, the second indication may comprise an indication of the presence/absence of the second uplink resource allocation in the first frame. In an embodiment, where the indication of presence/absence of the second uplink resource allocation indicates presence of the second uplink resource allocation, the second uplink resource allocation may have a same frequency resource as the first uplink resource allocation. In an embodiment, where the indication of presence/absence of the second uplink resource allocation indicates presence of the second uplink resource allocation, the second uplink resource allocation may have a same spatial resource as the first uplink resource allocation.

The first indication may indicate a first frequency resource and/or a first spatial resource associated with the first uplink resource allocation. In an embodiment, the second indication may indicate a second frequency resource and/or a second spatial resource associated with the second uplink resource allocation. In an embodiment, the first frame may further include a third indication associating the second indication with a second time resource and/or a fourth indication associating the first indication with a first time resource.

In an embodiment, the first frame may be a trigger frame. The trigger frame may comprise a user info field comprising the first indication. In an embodiment, the user info field may comprise an RU allocation field and/or an SS allocation field comprising the first indication. In an embodiment, the user info field may also comprise the second indication.

In step 1804, process 1800 may include receiving a second frame via the first resource allocation from the first STA. The second frame may include a TB PPDU.

In an embodiment, process 1800 may further include transmitting a third frame in response to the second frame. The third frame may include a BA or a multi-STA BA frame.

In an embodiment, process 1800 may further include receiving a fourth frame via the second uplink resource allocation from the first STA.

In an embodiment, a first time resource associated with the first uplink resource allocation starts at a first time spacing from an end of transmission of the first frame. The first time spacing may be equal to a short interframe spacing (SIFS) duration. In an embodiment, a second time resource associated with the second uplink resource allocation starts at a second time spacing from an end of transmission of the third frame transmitted in response to the second frame. The second time spacing may be equal to a SIFS duration.

In an embodiment, the first frame may further include a third indication associated with a third uplink resource allocation for a second STA. The third uplink resource allocation may be associated with a same time resource as the first uplink resource allocation or the second uplink resource allocation. In an embodiment, the third uplink resource allocation may be associated with a same time resource as the first uplink resource allocation but with a different frequency resource and/or a different spatial resource than the first uplink resource allocation. In an embodiment, process 1800 may further include receiving a third frame via the third uplink resource allocation from the second STA.

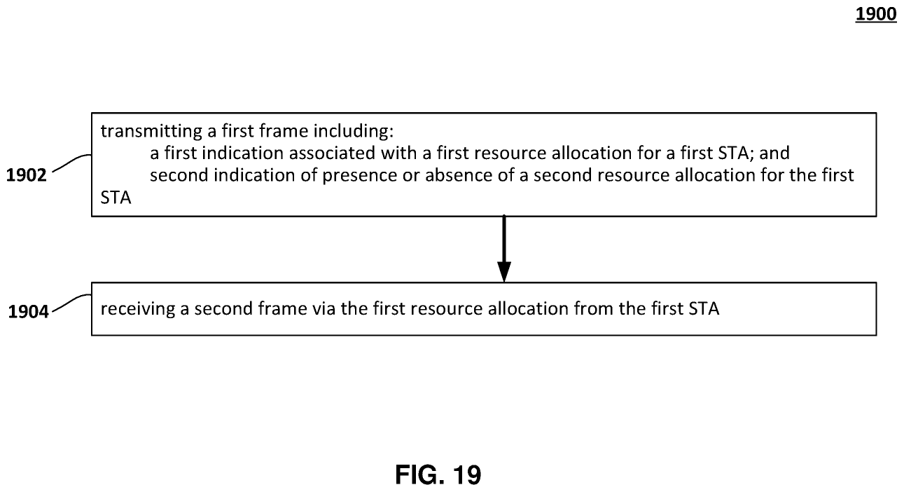

FIG. 19 illustrates an example process 1900 according to an embodiment. Example process 1900 is provided for the purpose of illustration only and is not limiting of embodiments. Example process 1900 may be performed by an AP, such as AP 902.

As shown in FIG. 19, process 1900 may include, in step 1902, transmitting a first frame including: a first indication associated with a first resource allocation for a first STA; and a second indication of presence or absence of a second resource allocation for the first STA.

In an embodiment, the first indication indicates a resource associated with the first uplink resource allocation. The resource may include a frequency resource and/or a spatial resource.

In an embodiment, where the second indication of presence/absence of the second uplink resource allocation indicates presence of the second uplink resource allocation, the second uplink resource allocation may have a same frequency resource as the first uplink resource allocation. In an embodiment, where the second indication of presence/absence of the second uplink resource allocation indicates presence of the second uplink resource allocation, the second uplink resource allocation may have a same spatial resource as the first uplink resource allocation.

In an embodiment, the first frame may be a trigger frame. The trigger frame may comprise a user info field comprising the first indication. In an embodiment, the user info field may comprise an RU allocation field and/or an SS allocation field comprising the first indication. In an embodiment, the user info field may also comprise the second indication.

In step 1904, process 1900 may include receiving a second frame via the first resource allocation from the first STA. The second frame may include a TB PPDU.

In an embodiment, process 1900 may further include transmitting a third frame in response to the second frame. The third frame may include a BA or a multi-STA BA frame.

In an embodiment, where the second indication indicates presence of the second uplink resource allocation, process 1900 may further include receiving a fourth frame via the second uplink resource allocation from the first STA.

In an embodiment, a first time resource associated with the first uplink resource allocation starts at a first time spacing from an end of transmission of the first frame. The first time spacing may be equal to a short interframe spacing (SIFS) duration. In an embodiment, a second time resource associated with the second uplink resource allocation starts at a second time spacing from an end of transmission of the third frame transmitted in response to the second frame. The second time spacing may be equal to a SIFS duration.

In an embodiment, the first frame may further include a third indication associated with a third uplink resource allocation for a second STA. The third uplink resource allocation may be associated with a same time resource as the first uplink resource allocation or the second uplink resource allocation. In an embodiment, the third uplink resource allocation may be associated with a same time resource as the first uplink resource allocation but with a different frequency resource and/or a different spatial resource than the first uplink resource allocation.

In an embodiment, process 1900 may further include receiving a third frame via the third uplink resource allocation from the STA.

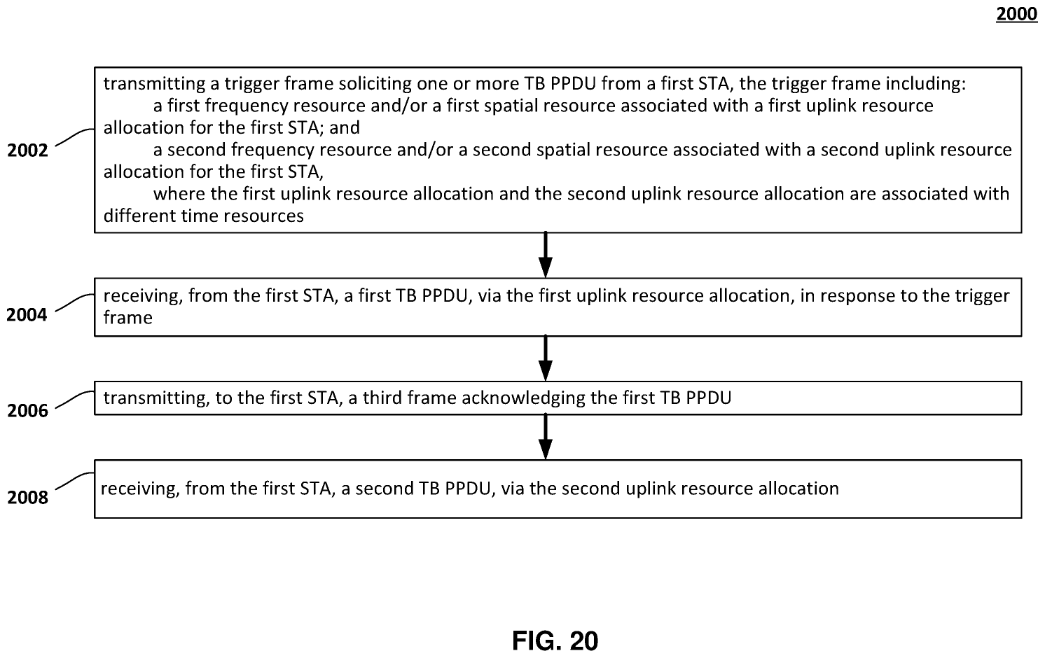

FIG. 20 illustrates an example process 2000 according to an embodiment. Example process 2000 is provided for the purpose of illustration only and is not limiting. Example process 2000 may be performed by an AP, such as AP 902.

As shown in FIG. 20, process 2000 may begin in step 2002, which includes transmitting a trigger frame soliciting one or more TB PPDU from a first STA. The trigger frame may include: a first frequency resource and/or a first spatial resource associated with a first uplink resource allocation for the first STA; and a second frequency resource and/or a first spatial resource associated with a second uplink resource allocation for the first STA, where the first uplink resource allocation and the second uplink resource allocation are associated with different time resources.

In an embodiment, the first indication may indicate a first frequency resource and/or a first spatial resource associated with the first uplink resource allocation. In an embodiment, the second indication may indicate a second frequency resource and/or a second spatial resource associated with the second uplink resource allocation. In an embodiment, the first frame may further include a third indication associating the second indication with a second time resource and/or a fourth indication associating the first indication with a first time resource.

In an embodiment, the trigger frame may comprise a first user info field comprising the first indication and a second user info field comprising the second indication. In an embodiment, the first user info field may comprise an RU allocation field and/or an SS allocation field comprising the first indication. In an embodiment, the second user info field may comprise an RU allocation field and/or an SS allocation field comprising the second indication.

In step 2004, process 2000 may include receiving, from the first STA, a first TB PDDU via the first uplink resource allocation, in response to the trigger frame.

In step 2006, process 2000 may include transmitting a third frame acknowledging the first TB PPDU. The third frame may include a BA or a multi-STA BA frame.

In step 2008, process 2000 may include receiving a second TB PPDU, via the second uplink resource allocation, from the first STA. The second TB PPDU may be transmitted in response to the third frame.

In an embodiment, a first time resource associated with the first uplink resource allocation starts at a first time spacing from an end of transmission of the trigger. The first time spacing may be equal to a short interframe spacing (SIFS) duration. In an embodiment, a second time resource associated with the second uplink resource allocation starts at a second time spacing from an end of transmission of the third frame transmitted in response to the first TB PPDU. The second time spacing may be equal to a SIFS duration.

In an embodiment, the trigger frame may further include a third indication associated with a third uplink resource allocation for a second STA. The third uplink resource allocation may be associated with a same time resource as the first uplink resource allocation or the second uplink resource allocation. In an embodiment, the third uplink resource allocation may be associated with a same time resource as the first uplink resource allocation but with a different frequency resource and/or a different spatial resource than the first uplink resource allocation. In an embodiment, process 2000 may further include receiving a third frame via the third uplink resource allocation from the second STA.

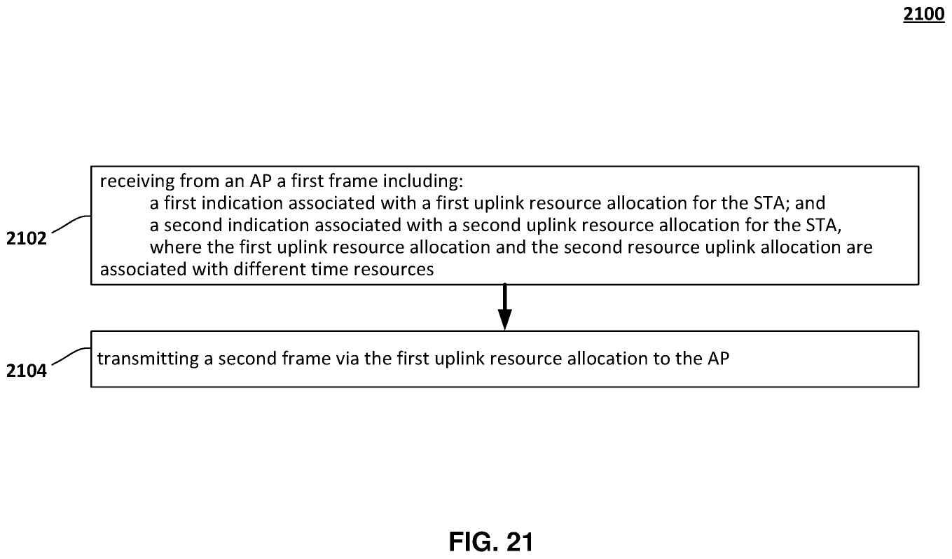

FIG. 21 illustrates an example process 2100 according to an embodiment. Example process 2100 is provided for the purpose of illustration and is not limiting of embodiments. Example process 2100 may be performed by a STA, such as STA 904, 1202, 1302, 1402, 1502, 1602, or 1702.

As shown in FIG. 21, process 2100 may begin in step 2102, which includes receiving a first frame from an AP. The first frame may include: a first indication associated with a first resource allocation for a first STA; and a second indication associated with a second resource allocation for the first STA. The first resource allocation and the second resource allocation may be associated with different time resources.

In an embodiment, the first indication indicates a resource associated with the first uplink resource allocation. The resource may include a frequency resource and/or a spatial resource.

In an embodiment, the second indication may comprise an indication of the presence/absence of the second uplink resource allocation in the first frame. In an embodiment, where the indication of presence/absence of the second uplink resource allocation indicates presence of the second uplink resource allocation, the second uplink resource allocation may have a same frequency resource as the first uplink resource allocation. In an embodiment, where the indication of presence/absence of the second uplink resource allocation indicates presence of the second uplink resource allocation, the second uplink resource allocation may have a same spatial resource as the first uplink resource allocation.

In an embodiment, the first indication may indicate a first frequency resource and/or a first spatial resource associated with the first uplink resource allocation. In an embodiment, the second indication may indicate a second frequency resource and/or a second spatial resource associated with the second uplink resource allocation. In an embodiment, the first frame may further include a third indication associating the second indication with a second time resource and/or a fourth indication associating the first indication with a first time resource.

In an embodiment, the first frame may be a trigger frame. The trigger frame may comprise a user info field comprising the first indication. In an embodiment, the user info field may comprise an RU allocation field and/or an SS allocation field comprising the first indication. In an embodiment, the user info field may also comprise the second indication.

In step 2104, process 2100 may include transmitting a second frame via the first uplink resource allocation to the AP. The second frame may be transmitted in response to the first frame. The second frame may include a TB PPDU.

In an embodiment, process 2100 may further include receiving, from the AP, a third frame in response to the second frame. The third frame may be a BA or a multi-STA BA frame. The BA frame may be a compressed BA frame.

In an embodiment, a first time resource associated with the first uplink resource allocation starts at a first time spacing from an end of transmission of the first frame. The first time spacing may be equal to a short interframe spacing (SIFS) duration. In an embodiment, a second time resource associated with the second uplink resource allocation starts at a second time spacing from an end of transmission of the third frame transmitted in response to the second frame. The second time spacing may be equal to a SIFS duration.

In an embodiment, process 2100 may further include transmitting, to the AP, a fourth frame via the second uplink resource allocation regardless of content of the third frame. In another embodiment, process 2100 may further include decoding the third frame; and determining whether to transmit a fourth frame via the second uplink resource allocation based on the decoding of the third frame. In an embodiment, where the decoding of the third frame indicates unsuccessful reception by the AP of an MPDU or an A-MPDU contained in the second frame, process 2100 may further include transmitting, to the AP, the fourth frame via the second uplink resource allocation. In another embodiment, where the decoding of the third frame indicates successful reception by the AP of an MPDU or an A-MPDU contained in the second frame, process 2100 may further include not transmitting, to the AP, the fourth frame via the second uplink resource allocation.

In an embodiment, the fourth frame may be the same as the second frame. In an embodiment, the second frame and the fourth frame include a first TB PPDU and a second TB PPDU respectively, and the first TB PPDU and the second TB PPDU are of equal length. In an embodiment, a PSDU of the second TB PPDU is shorter than a PSDU of the first PPDU. Where the first TB PPDU and the second TB PPDU are of equal length, the second TB PPDU may include padding bits.

In an embodiment, the first frame may further indicate: a third indication associated with a third uplink resource allocation for a second STA; and a fourth indication associated with a fourth uplink resource allocation for the second STA. In an embodiment, transmitting the fourth frame may comprise transmitting the fourth frame via the second uplink resource allocation and/or the third uplink resource allocation. In an embodiment, where the fourth indication comprises an indication of presence/absence of the fourth uplink resource allocation for the second STA, transmitting the fourth frame may comprise transmitting the second frame via the second uplink resource allocation and/or the third uplink resource allocation based on the fourth indication. In an embodiment, where the indication of presence/absence of the fourth uplink resource allocation for the second STA indicates absence of the fourth uplink resource allocation for the second STA, transmitting the fourth frame may comprise transmitting the fourth frame via a combined resource allocation comprising the second uplink resource allocation and the third uplink resource allocation. In an embodiment, where the indication of presence/absence of the fourth uplink resource allocation for the second STA indicates absence of the fourth uplink resource allocation for the second STA, transmitting the fourth frame may comprise: transmitting the fourth frame via the second uplink resource allocation; and transmitting the fourth frame via the third uplink resource allocation. In an embodiment, where the indication of presence/absence of the fourth uplink resource allocation for the second STA indicates absence of the fourth uplink resource allocation for the second STA, transmitting the fourth frame may comprise transmitting the fourth frame via the third uplink resource allocation.

In an embodiment, the second uplink resource allocation and the fourth uplink resource allocation are associated with a same time resource.

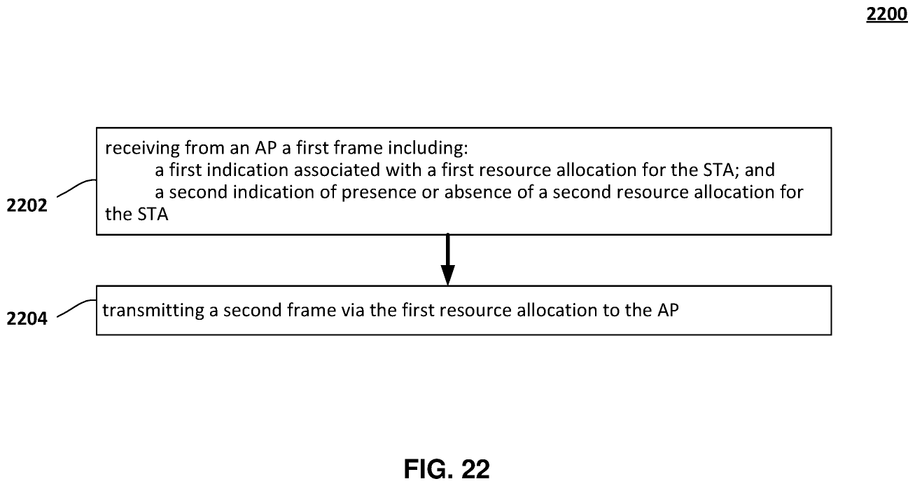

FIG. 22 illustrates an example process 2200 according to an embodiment. Example process 2200 is provided for the purpose of illustration only and is not limiting of embodiments. Example process 2200 may be performed by a STA, such as STA 904, 1202, 1302, 1402, 1502, 1602, or 1702.

As shown in FIG. 22, process 2200 may begin in step 2202, which includes receiving from an AP a first frame including: a first indication associated with a first resource allocation for the STA; and a second indication of presence or absence of a second resource allocation for the STA.

In an embodiment, the first indication indicates a resource associated with the first uplink resource allocation. The resource may include a frequency resource and/or a spatial resource.

In an embodiment, where the second indication of presence/absence of the second uplink resource allocation indicates presence of the second uplink resource allocation, the second uplink resource allocation may have a same frequency resource as the first uplink resource allocation. In an embodiment, where the second indication of presence/absence of the second uplink resource allocation indicates presence of the second uplink resource allocation, the second uplink resource allocation may have a same spatial resource as the first uplink resource allocation.

In an embodiment, the first frame may be a trigger frame. The trigger frame may comprise a user info field comprising the first indication. In an embodiment, the user info field may comprise an RU allocation field and/or an SS allocation field comprising the first indication. In an embodiment, the user info field may also comprise the second indication.

In step 2204, process 2200 may include transmitting, to the AP, a second frame via the first resource allocation. The second frame may be transmitted in response to the first frame. The second frame may include a TB PPDU.

In an embodiment, process 2200 may further include receiving, from the AP, a third frame in response to the second frame. The third frame may be a BA or a multi-STA BA frame. The BA frame may be a compressed BA frame.

In an embodiment, the first uplink resource allocation and the second uplink resource allocation are associated with different time resources. In an embodiment, a first time resource associated with the first uplink resource allocation starts at a first time spacing from an end of transmission of the first frame. The first time spacing may be equal to a short interframe spacing (SIFS) duration. In an embodiment, a second time resource associated with the second uplink resource allocation starts at a second time spacing from an end of transmission of the third frame transmitted in response to the second frame. The second time spacing may be equal to a SIFS duration.

In an embodiment, where the second indication indicates presence of the seocnd uplink resource allocation, process 2200 may further include transmitting, to the AP, a fourth frame via the second uplink resource allocation regardless of content of the third frame. In another embodiment, process 2200 may further include decoding the third frame; and determining whether to transmit a fourth frame via the second uplink resource allocation based on the decoding of the third frame. In an embodiment, where the decoding of the third frame indicates unsuccessful reception by the AP of an MPDU or an A-MPDU contained in the second frame, process 2200 may further include transmitting, to the AP, the fourth frame via the second uplink resource allocation. In another embodiment, where the decoding of the third frame indicates successful reception by the AP of an MPDU or an A-MPDU contained in the second frame, process 2200 may further include not transmitting, to the AP, the fourth frame via the second uplink resource allocation.

In an embodiment, the fourth frame may be the same as the second frame. In an embodiment, the second frame and the fourth frame include a first TB PPDU and a second TB PPDU respectively, and the first TB PPDU and the second TB PPDU are of equal length. In an embodiment, a PSDU of the second TB PPDU is shorter than a PSDU of the first PPDU. Where the first TB PPDU and the second TB PPDU are of equal length, the second TB PPDU may include padding bits.

In an embodiment, the first frame may further indicate: a third indication associated with a third uplink resource allocation for a second STA; and a fourth indication associated with a fourth uplink resource allocation for the second STA. In an embodiment, transmitting the fourth frame may comprise transmitting the fourth frame via the second uplink resource allocation and/or the third uplink resource allocation. In an embodiment, where the fourth indication comprises an indication of presence/absence of the fourth uplink resource allocation for the second STA, transmitting the fourth frame may comprise transmitting the second frame via the second uplink resource allocation and/or the third uplink resource allocation based on the fourth indication. In an embodiment, where the indication of presence/absence of the fourth uplink resource allocation for the second STA indicates absence of the fourth uplink resource allocation for the second STA, transmitting the fourth frame may comprise transmitting the fourth frame via a combined resource allocation comprising the second uplink resource allocation and the third uplink resource allocation. In an embodiment, where the indication of presence/absence of the fourth uplink resource allocation for the second STA indicates absence of the fourth uplink resource allocation for the second STA, transmitting the fourth frame may comprise: transmitting the fourth frame via the second uplink resource allocation; and transmitting the fourth frame via the third uplink resource allocation. In an embodiment, where the indication of presence/absence of the fourth uplink resource allocation for the second STA indicates absence of the fourth uplink resource allocation for the second STA, transmitting the fourth frame may comprise transmitting the fourth frame via the third uplink resource allocation.

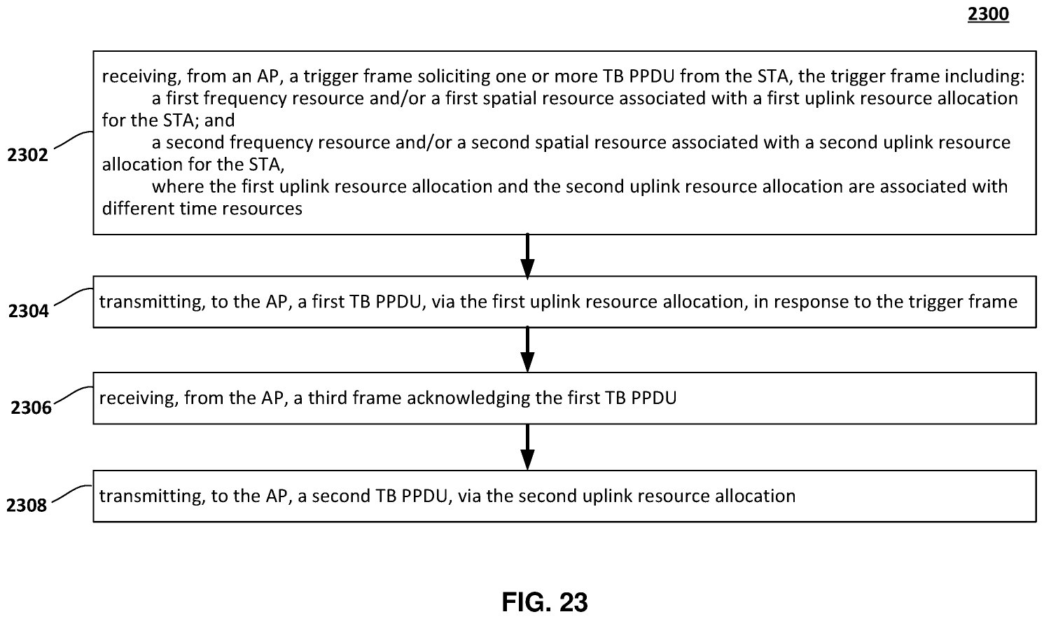

FIG. 23 illustrates an example process 2300 according to an embodiment. Example process 2300 is provided for the purpose of illustration only and is not limiting. Example process 2300 may be performed by a STA, such as such as STA 904, 1202, 1302, 1402, 1502, 1602, or 1702.

As shown in FIG. 2300, process 2300 may begin in step 2302, which includes receiving, from an AP, a trigger frame soliciting one or more TB PPDU from the STA. The trigger frame may include: a first frequency resource and/or spatial resource associated with a first uplink resource allocation for the first STA; and a second frequency resource and/or spatial resource associated with a second uplink resource allocation for the first STA, where the first uplink resource allocation and the second uplink resource allocation are associated with different time resources.

In an embodiment, the first indication may indicate a first frequency resource and/or a first spatial resource associated with the first uplink resource allocation. In an embodiment, the second indication may indicate a second frequency resource and/or a second spatial resource associated with the second uplink resource allocation. In an embodiment, the first frame may further include a third indication associating the second indication with a second time resource and/or a fourth indication associating the first indication with a first time resource.

In an embodiment, the trigger frame may comprise a first user info field comprising the first indication and a second user info field comprising the second indication. In an embodiment, the first user info field may comprise an RU allocation field and/or an SS allocation field comprising the first indication. In an embodiment, the second user info field may comprise an RU allocation field and/or an SS allocation field comprising the second indication.

In step 2304, process 2300 may include transmitting, to the first STA, a first TB PDDU via the first uplink resource allocation, in response to the trigger frame.

In step 2306, process 2300 may include receiving, from the AP, a third frame acknowledging the first TB PPDU. The third frame may include a BA or a multi-STA BA frame.

In step 2308, process 2300 may include transmitting, to the AP, a second TB PPDU, via the second uplink resource allocation. The second TB PPDU may be transmitted in response to the third frame.

In an embodiment, a first time resource associated with the first uplink resource allocation starts at a first time spacing from an end of transmission of the trigger. The first time spacing may be equal to a short interframe spacing (SIFS) duration. In an embodiment, a second time resource associated with the second uplink resource allocation starts at a second time spacing from an end of transmission of the third frame transmitted in response to the first TB PPDU. The second time spacing may be equal to a SIFS duration.

In an embodiment, the trigger frame may further include a third indication associated with a third uplink resource allocation for a second STA. The third uplink resource allocation may be associated with a same time resource as the first uplink resource allocation or the second uplink resource allocation. In an embodiment, the third uplink resource allocation may be associated with a same time resource as the first uplink resource allocation but with a different frequency resource and/or a different spatial resource than the first uplink resource allocation.

As described above, operation according to the proposed procedure described in FIGS. 9-17 allows an AP to allocate one or more STAs, using a single trigger frame, multiple uplink resources for use in different time resources (e.g., an initial transmission and one or more subsequent transmissions or re-transmissions). The procedure however requires that the AP transmit an acknowledgment frame following each time resource to acknowledge frames received during the time resource. For example, as described earlier with respect to FIG. 9, AP 902 transmits a multi-STA BA frame 914 to STAs 910 and 912 after a first time resource in which frames 910 and 912 are received from STAs 904 and 912 respectively. Similarly, after a second time resource in which frame 916 is received from STA 904, AP 902 transmits a BA frame 918 to STA 904. Clearly, as the number of time resources indicated by the trigger frame increases, the AP would need to transmit an equivalently large number of corresponding acknowledgment frames. However, for certain types of traffic (e.g., best effort traffic, non-latency-sensitive traffic, etc.), the traffic from the STA may be sustained with an acceptable performance without the need for an acknowledgment from the AP after each time resource. The procedure as described above in FIGS. 9-17 may thus be modified according to embodiments to eliminate one or more intervening acknowledgment frames transmitted by the AP (acknowledgment frames transmitted by the AP in between two successive time resources indicated by the trigger frame) during the procedure. As further described below, in an embodiment, the AP may be configured to transmit a single acknowledgment frame after all time resources indicated in the trigger frame have been used. In another embodiment, the AP may be configured to selectively transmit intervening acknowledgments frames during the procedure.

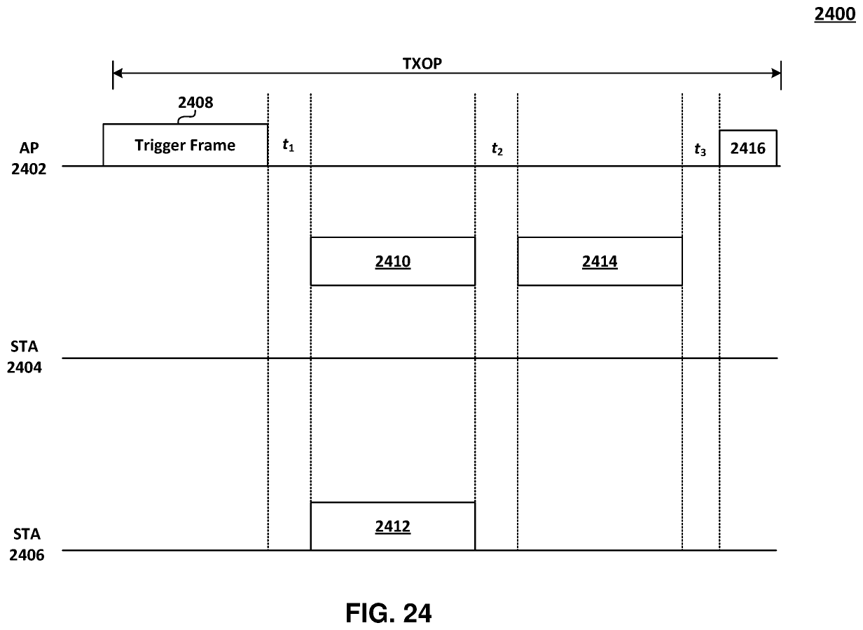

FIG. 24 illustrates an example 2400 of uplink transmission in response to a trigger frame according to an embodiment. Example 2400 is provided for the purpose of illustration only and is not limiting of embodiments of the present disclosure. As shown in FIG. 24, example 2400 includes an AP 2402, a STA 2404, and a STA 2406. In an example, STAs 2404 and 2406 may be associated with AP 2402.

In an example, AP 2402 may obtain a TXOP and transmit a trigger frame 2408 to STAs 2404 and 2406. Trigger frame 2408 may be a frame that solicits one or more trigger-based (TB) physical layer (PHY) protocol data unit (PPDU) from one or more of STAs 2404 and 2406. In an embodiment, trigger frame 2408 may be a Basic Trigger frame variant according to the IEEE 802.11 ax/be standard amendment. In another embodiment, trigger frame 2408 may be a new trigger frame variant such as a Low Latency (LL) trigger frame variant.

In an embodiment, trigger frame 2408 includes a first indication associated with a first uplink resource allocation for the STA 2404; a second indication associated with a second uplink resource allocation for STA 2404; and a third indication whether an aggregated acknowledgment mode is enabled. In an embodiment, an uplink resource allocation may include a frequency resource and/or a spatial resource. The uplink resource allocation is associated with a time resource associated with a transmission interval.

A frequency resource may include a resource unit (RU), which includes one or more tones or frequency subcarriers. A spatial resource may include one or more spatial dimensions. A spatial dimension may be created by the use of multiple antennas at both ends of a communication link. A spatial stream may comprise a bit stream or modulated symbols transmitted over a respective spatial dimension.

In an embodiment, the first uplink resource allocation and the second resource uplink allocation contained in trigger frame 2408 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval. In an embodiment, the first/second transmission interval may correspond in duration to a time division duplex (TDD) slot as defined in the IEEE 802.11 standard. In another embodiment, the first/second transmission interval may correspond in duration to a portion of a TDD slot as defined in the IEEE 802.11 standard.

In an embodiment, when the aggregated acknowledgment mode is enabled, AP 2402 may delay the transmission of an acknowledgment frame (e.g., BA, multi-STA BA, etc.) in response to a first frame received, during a first time resource, from one of STAs 2404 and 2406. AP 2402 may aggregate the acknowledgment to the first frame with an acknowledgment to a second frame received, during a subsequent second time resource, from one of STAs 2404 and 2406.

In an embodiment, AP 2402 may enable/disable the aggregated acknowledgment mode based on one or more of: a number of STAs allocated by trigger frame 2408, a number of time resources indicated in trigger frame 2408, and the types of traffic from STAs 2404 and 2406. For example, if the number of STAs allocated by trigger frame 2408 is greater than a threshold, AP 2402 may choose to enable the aggregated acknowledgment mode. Alternatively or additionally, AP 2402 may enable the aggregated acknowledgment mode when the number of time resources indicated by trigger frame 2408 is greater than a threshold. In another embodiment, AP 2402 may enable the aggregated acknowledgment mode when the traffic from STA 2404 and/or STA 2406 is best effort traffic or non-latency sensitive traffic, for example. Alternatively or additionally, AP 2402 may enable the aggregated acknowledgment mode when a STA transmission mode includes duplicate frame transmissions (e.g., BA transmissions or ARQ transmissions).

In an embodiment, the aggregated acknowledgment mode may be enabled/disabled on a per-STA basis. For example, AP 2402 may enable the aggregated acknowledgment mode for STA 2404 but disable it for STA 2406. In such an embodiment, trigger frame 2408 may include separate indications for STA 2404 and 2406 as to whether the aggregated acknowledgment mode is enabled.

On receiving trigger frame 2408, STA 2404 may read the first, second, and third indications included in trigger frame 2408. Based on the first and second indications, STA 2404 may determine the first and second uplink resource allocations assigned to it by AP 2402. STA 2404 may also identify the time resources associated with the first and second uplink resource allocations. Using the third indication, STA 2404 may determine whether AP 2402 has enabled or disabled the aggregated acknowledgment mode. The third indication may be specific to STA 2404 or general to all STAs being allocated by trigger frame 2408.

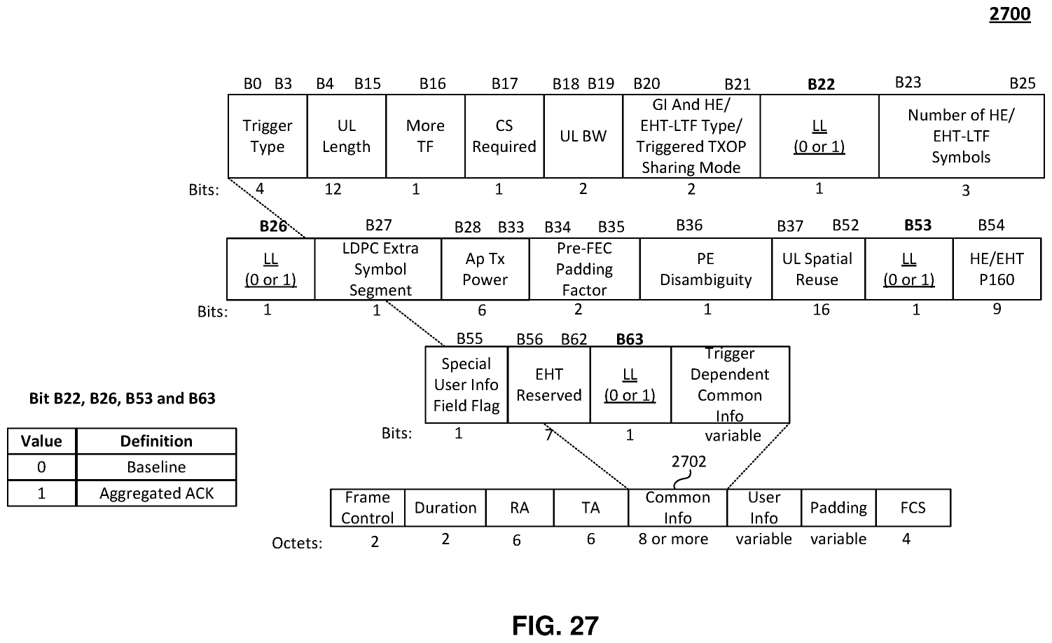

In an example, it is assumed that AP 2402 has enabled the aggregated acknowledgment mode in trigger frame 2408. In an embodiment, trigger frame 2408 comprises a Common Info field, and the third indication is provided in the Common Info field. In an embodiment, the third indication is provided in a Low Latency (LL) subfield of the Common Info field. In an embodiment, a value of 1 for the LL subfield may indicate that an aggregated acknowledgment mode is enabled. In an embodiment, trigger frame 2408 may have a format as illustrated by trigger frame 2700 shown in FIG. 27. Trigger frame 2700 may be a modified basic trigger frame. In an embodiment, the LL subfield may be provided in any of Bits 22, 26, 53, or 63 of the Common Info of trigger frame 2700. As such, the LL subfield replaces a Reserved Bit in one of Bits 22, 26, 53, or 63 of the Common Info field of the basic trigger frame.

In response to trigger frame 2408, STA 2404 may transmit a frame 2410, via the first uplink resource allocation, to AP 2402. Frame 2410 may include a TB PPDU. In an embodiment, as shown in FIG. 24, the first time resource associated with the first uplink resource allocation starts at a first time spacing t₁ from an end of transmission of trigger frame 2408. In an embodiment, the first time spacing t₁ may be less than or equal to a SIFS.

In an embodiment, frame 2410 may comprise an acknowledgment policy indicator that indicates whether STA 2404 requires an acknowledgment in response to frame 2410. In an embodiment, when the aggregated acknowledgment mode is enabled in trigger frame 2408 and/or when frame 2412 is not being transmitted in a last time resource indicated by trigger frame 2408, frame 2410 may comprise an acknowledgment policy indicator set to indicate that no acknowledgment is requested from AP 2402. In an embodiment, the acknowledgment policy indicator may be set to Block Ack based on which AP 2402 takes no action upon the receipt of frame 2410 (except for recording the state). AP 2402 can expect a BlockAckReq frame or an implicit block ack request in the future from STA 2404 to which AP 2402 may respond by sending a BA frame. As shown in FIG. 4, the acknowledgment policy indicator may be provided in an Ack Policy Indicator field of a QoS Control field of frame 2410. In an embodiment, when the acknowledgment policy indicator is set to Block Ack, the acknowledgment policy indicator may be set to the value (11).

In an embodiment, trigger frame 2408 may further include a third uplink resource allocation for STA 2406. In an embodiment, as shown in FIG. 24, the third uplink resource allocation may be associated with a same time resource as the first uplink resource allocation allocated to STA 2404. The third uplink resource allocation may be associated with a different frequency resource and/or a different spatial resource than the first uplink resource allocation. In another embodiment, the third uplink resource allocation may be associated with a same time resource as the second uplink resource allocation allocated to STA 2404. The third uplink resource allocation may be associated with a different frequency resource and/or a different spatial resource than the second uplink resource allocation.

In response to trigger frame 2408, STA 2406 may transmit a frame 2412, via the first uplink resource allocation, to AP 2402. Frame 2412 may include a TB PPDU. In an embodiment, as shown in FIG. 24, the first time resource associated with the third uplink resource allocation starts at a first time spacing t₁ from an end of transmission of trigger frame 2408. In an embodiment, the first time spacing t₁ may be less than or equal to a SIFS.

In an embodiment, frame 2412 may comprise an acknowledgment policy indicator that indicates whether STA 2406 requires an acknowledgment in response to frame 2412. In an embodiment, when the aggregated acknowledgment mode is enabled in trigger frame 2408 and/or when frame 2412 is not being transmitted in a last time resource indicated by trigger frame 2408, frame 2412 may comprise an acknowledgment policy indicator set to indicate that no acknowledgment is requested from AP 2402. In an embodiment, the acknowledgment policy indicator may be set to Block Ack based on which AP 2402 takes no action upon the receipt of frame 2412 (except for recording the state). AP 2402 can expect a BlockAckReq frame or an implicit block ack request in the future from STA 2406 to which AP 2402 may respond by sending a BA frame. In an embodiment, STA 2406 may send a BlockAckReq frame (or an implicit block request) 2418 during the second time resource indicated in trigger frame 2408. In response, AP 2402 may send a multi-STA BA frame to STA 2406. The multi-STA BA frame may acknowledge frame 2412 in addition to acknowledging previously received frames from STA 2404 (e.g., frames 2410 and 2414). In another embodiment, STA 2406 may send a BlockAckReq frame or an implicit block request in a subsequent TXOP to the one indicated in trigger frame 2408. In response, AP 2402 may send a BA frame to STA 2406 only acknowledging frame 2412.

In another embodiment, when the aggregated acknowledgment mode is enabled in trigger frame 2408 and/or when frame 2412 is being transmitted in the last time resource allocated to STA 2406 by trigger frame 2408, the acknowledgment policy indicator in frame 2412 may be set to implicit BAR. According to existing standard operation, when a recipient receives a frame with the acknowledgement policy indicator set to Implicit BAR, the recipient returns a BlockAck starting a SIFS after the received frame. In an embodiment, the existing standard operation may be modified such that AP 2402 does not return a BlockAck one SIFS after receiving frame 2412 but instead waits until all time resources indicated in trigger frame 2408 have been used or has elapsed. As such, in example 2400, AP 2402 may not respond with a BlockAck in response to frame 2412 having an acknowledgment policy indicator set to implicit BAR and may wait until the second time resource indicated in trigger frame 2408 has been used or has elapsed. For example, AP 2402 may wait to receive frame 2414 from STA 2404 during the second time resource before responding to frame 2412 from STA 2406 with a multi-STA BA frame for example.

As shown in FIG. 4, the acknowledgment policy indicator may be provided in an Ack Policy Indicator field of a QoS Control field of frame 2412. In an embodiment, when the acknowledgment policy indicator is set to Implicit BAR, the acknowledgment policy indicator may be set to the value (00).

Upon receiving frames 2410 and 2412, AP may determine whether to transmit an acknowledgment (e.g., multi-STA BA) in response to frame 2410 and/or frame 2412. In an embodiment, AP 2402 may operate based on the aggregated acknowledgment mode as set in trigger frame 2408. That is, if the aggregated acknowledgment mode was enabled in trigger frame 2408, AP 2402 may ignore the acknowledgment policy indicators included in frames 2410 and 2412 and may only transmit an acknowledgment after all uplink resource allocations indicated in trigger frame 2408 have been used by the allocated STAs. Otherwise, if the aggregated acknowledgment mode was disabled in trigger frame 2408, AP 2402 may act in accordance with the acknowledgment policy indicators included in frames 2410 and 2412. Specifically, AP 2402 may respond to frames 2410 and 2412 in accordance with existing standard procedures. In an embodiment, when the aggregated acknowledgment mode is enabled, if the acknowledgment policy indicators of frames 2410 and 2412 are both set to BlockAck, AP 2408 does not transmit an acknowledgment after receiving frames 2410 and 2412. In another embodiment, when the aggregated acknowledgment mode is enabled, if at least one of frames 2410 and 2412 requests an acknowledgment (e.g., acknowledgment policy indicator set to Implicit BAR), AP 2402 may transmit an acknowledgment frame in the form of a BA or a multi-STA BA frame after receiving frames 2410 and 2412. In a further embodiment, when the aggregated acknowledgment mode is enabled, AP 2402 may not transmit an acknowledgment frame even if one or more of frames 2410 and 2412 requests an acknowledgment (e.g., acknowledgment policy indicator set to Implicit BAR); instead, AP 2402 may wait for all indicated time resources to have been used or to have elapsed before sending an acknowledgment in the form of a BA or a multi-STA BA frame.

In another embodiment, AP 2402 may operate based on the aggregated acknowledgment mode as set in trigger frame 2408 but may further consider the acknowledgment policy indicators included in frames 2410 and 2412. In an embodiment, the acknowledgment policy indicator included in frame 2410 or 2412 may override the aggregated acknowledgment mode setting in trigger frame 2408 for STA 2404 or STA 2406. For example, if the aggregated acknowledgment mode was enabled in trigger frame 2408 but the acknowledgment policy indicator of frame 2410 indicates that an acknowledgment is requested, AP 2402 may transmit an acknowledgment frame in response to frame 2410 despite the aggregated acknowledgment mode being enabled. As such, STA 2404 may indicate to AP 2402 that it chooses not to operate using the aggregated acknowledgment mode being enabled.

In an embodiment, after transmitting frame 2410, STA 2404 may proceed to transmit a frame 2414, via the second uplink resource allocation, to AP 2404. Frame 2414 may include a TB PPDU. In an embodiment, STA 2404 may transmit frame 2414 without waiting to receive an acknowledgment from AP 2402. In an embodiment, as shown in FIG. 24, when STA 2404 transmits frame 2414 without waiting to receive an acknowledgment from AP 2402, frame 2414 may be transmitted during a second resource that starts at a second time spacing t₂ from an end of transmission of frame 2410. In an embodiment, the second time spacing t₂ is less than or equal to a SIFS duration. In an embodiment, frame 2414 may be a retransmission of frame 2410 transmitted during the first time resource. As such, the overhead reduction due to the non-transmission of an acknowledgment from AP 2402 may be translated into an increased reliability of frame transmission between STA 2404 and AP 2402.

In an embodiment, STA 2404 may decide whether to wait for an acknowledgment from AP 2402 based on the aggregated acknowledgment mode. That is, if the aggregated acknowledgment mode is enabled in trigger frame 2408, STA 2404 may decide not to wait for an acknowledgment from AP 2402 and may proceed with transmitting frame 2414 after a second time spacing t₂ from an end of transmission of frame 2410. Otherwise, if the aggregated acknowledgment mode is disabled in trigger frame 2408, STA 2404 may decide to wait for an acknowledgment from AP 2402 before transmitting frame 2414.

In another embodiment, STA 2404 may decide whether to wait for an acknowledgment from AP 2402 based on other considerations than the aggregated acknowledgment mode. In an embodiment, STA 2404 may decide whether or not to wait for an acknowledgment from AP 2402 based on the acknowledgment policy indicator set in frame 2410. That is, if the acknowledgment policy indicator in frame 2410 requested an immediate acknowledgment (e.g., set to implicit BAR), STA 2404 may wait for the acknowledgment from AP 2402 before transmitting frame 2414. Otherwise, if the acknowledgment policy indicator in frame 2410 did not request an immediate acknowledgment (e.g., set to BA indication), STA 2404 may not wait for the acknowledgment from AP 2402 before transmitting frame 2414.

In an embodiment, when the aggregated acknowledgment mode is enabled in trigger frame 2408, and based on frame 2414 being transmitted in the last time resource allocated to STA 2404 by trigger frame 2408, the acknowledgment policy indicator in frame 2414 may be set to implicit BAR. According to existing standard operation, when a recipient receives a frame with the acknowledgement policy indicator set to Implicit BAR, the recipient returns a BlockAck starting a SIFS after the received frame.

In an embodiment, on receiving frame 2414, AP 2402 may transmit a frame 2416. As described above, frame 2416 may be a BA frame or a multi-STA BA frame acknowledging frame 2410, 2412, and/or 2414. Frame 2416 may be transmitted at a third time spacing t₃ from an end of transmission of frame 2414. The third time spacing t₃ may be less than or equal to a SIFS duration.

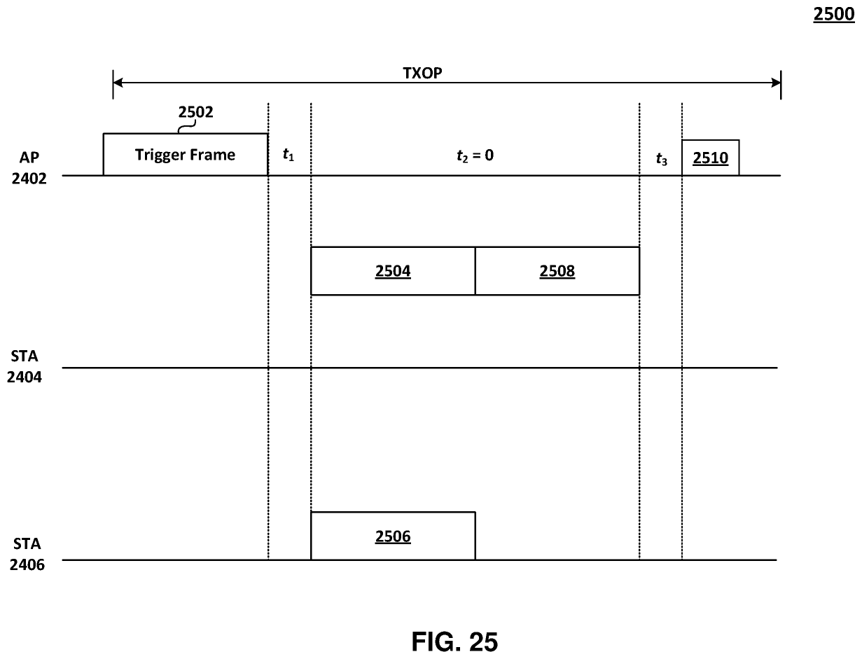

FIG. 25 illustrates an example 2500 of uplink transmission in response to a trigger frame according to an embodiment. Example 2500 is provided for the purpose of illustration only and is not limiting of embodiments of the present disclosure. As shown in FIG. 25, like example 2400, example 2500 also includes AP 2402, STA 2404, and STA 2406. In an example, STAs 2404 and 2406 may be associated with AP 2402.

In an example, AP 2402 may obtain a TXOP and transmit a trigger frame 2502 to STAs 2404 and 2406. Trigger frame 2502 may be a frame that solicits one or more trigger-based (TB) physical layer (PHY) protocol data unit (PPDU) from one or more of STAs 2404 and 2406. In an embodiment, trigger frame 2502 may be a Basic Trigger frame variant according to the IEEE 802.11 ax/be standard amendment. In another embodiment, trigger frame 2502 may be a new trigger frame variant such as a Low Latency (LL) trigger frame variant. Once an AP 2402 gains access to the medium, it maintains control of the medium by keeping a minimum time spacing between frames.

In an embodiment, trigger frame 2502 includes a first indication associated with a first uplink resource allocation for the STA 2404; a second indication associated with a second uplink resource allocation for STA 2404; and a third indication whether an aggregated acknowledgment mode is enabled. In an embodiment, the first uplink resource allocation and the second resource uplink allocation contained in trigger frame 2502 are associated with different time resources. In an embodiment, the first uplink resource allocation is associated with a first time resource, and the second uplink resource allocation is associated with a second time resource. The first time resource may be associated with a first transmission interval, and the second time resource may be associated with a second transmission interval different than the first transmission interval.

In an embodiment, trigger frame 2502 may further include one or more fourth indications of inter-frame time spacings. The one or more time spacings may include a first time spacing (shown as t₁ in FIG. 25), a second time spacing (shown as t₂ in FIG. 25), and a third time spacing (shown as t₃ in FIG. 25). In another embodiment, the one or more time spacings may be communicated to the STAs in a different frame than trigger frame 2502, such as in a control frame.

The first time spacing (shown as t₁ in FIG. 25) may correspond to a time spacing between an end of transmission of trigger frame 2502 and a start of a first time resource for uplink transmission in response to trigger frame 2508. In example 2500, STAs 2404 and 2406 use the first time resource to transmit frames 2504 and 2506 respectively. As such, the first time spacing also corresponds to an inter-frame time spacing between trigger frame 2502 and each of frames 2504 and 2506. In embodiments, the first time spacing may be less than or equal to a SIFS.

The second time spacing (shown as t₂ in FIG. 25) may correspond to a time spacing between time resources associated with trigger frame 2502. If trigger frame 2502 is associated with a first time resource and a second time resource as in example 2500, the second time spacing may correspond to the time spacing between the first time resource and the second time resource. Similarly, if trigger frame 2502 is associated with a third time resource following the second time resource, the second time spacing may also correspond to the time spacing between the second time resource and the third time resource. In embodiments, the second time spacing may be less than or equal to a SIFS. In an embodiment, as shown in FIG. 25, the second time spacing may be equal to zero. In example 2500, STA 2404 uses the first and second time resources associated with trigger frame 2502 to transmit frames 2504 and 2508 respectively. As such, the second time spacing also corresponds to an inter-frame time spacing between frames 2504 and 2508.

The third time spacing (shown as t₃ in FIG. 25) may correspond to a time spacing between an end of a last time resource for uplink transmission in response to trigger frame 2502 and a start of transmission of an acknowledgment frame for frames transmitted in response to trigger frame 2502. In example 2500, STA 2404 uses the second (and last) time resource to transmit frame 2508 in response to trigger frame 2502. As such, the third time spacing corresponds to an inter-frame time spacing between frame 2508 and an acknowledgment frame 2510 transmitted by AP 2402 in response to frames 2504, 2506, and 2510. In embodiments, the third time spacing may be less than or equal to a SIFS.

In an embodiment, the first time spacing and/or the third time spacing may be set to a value greater than zero. This ensures that a sufficient separation is provided between a response frame and the frame that solicited the response frame (e.g., between frame 2504 or 2506 and trigger frame 2502, or between acknowledgment frame 2510 and frame 2508). The second time spacing, however, which separates frames 2504 and 2508 both transmitted by STA 2404 to AP 2402 may be set to zero. The setting of the second time spacing (t₂) to zero may reduce the probability of another radio starting to transmit during the frame burst of frames 2504 and 2508. Additionally, the transmission time of STA 2404 is reduced as frames 2504 and 2508 may be transmitted as a burst without intervening idle times.

In an embodiment, the behavior of AP 2402, STA 2404, and STA 2406 in response to the aggregated acknowledgment mode being enabled/disabled may be as described above with respect to FIG. 24. For the purpose of conciseness, this description is not repeated herein and its applicability to this embodiment would be apparent to a person of skill in the art based on the teachings herein.

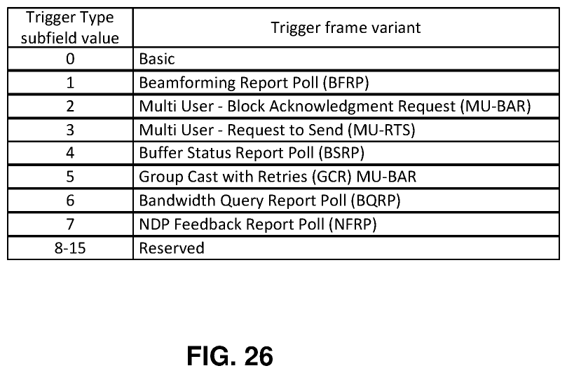

FIG. 26 illustrates an encoding of a Trigger Type subfield of a trigger frame in accordance with the IEEE 802.11 ax/be standard amendments. As described earlier, trigger frames may be used to trigger certain frame exchanges for uplink (UL) multi-user (MU) operation. For example, a trigger frame may be used by an AP to allocate UL resource units (RUs) to STAs. STAs may respond to the trigger frame with simultaneous UL transmissions to the AP via the allocated RUs (UL MU operation). As shown in FIG. 26, the IEEE 802.11 ax/be standard amendments define multiple trigger frame variants which may be used to enable UL MU operation. The Trigger frame also carries other information required by the responding STA to send an HE TB PPDU. The trigger frame variant is signaled by the AP in a Trigger Type subfield of a Common Info field of the trigger frame.

According to the IEEE 802.11 ax/be standard amendments, the Trigger Type subfield value ranges from 0 to 15. A value of 0 represents a Basic trigger frame variant, which may be used for UL MU operation to signal the STAs to begin uplink transmission of their data with their assigned RUs. A value of 1 denotes a Beamforming Report Poll (BFRP) trigger frame variant, which may be used for UL MU operation that includes retrieving beamforming reports from multiple STAs. A value of 2 denotes an MU-Block Acknowledgment Request (BAR) trigger frame variant, which may be used for UL MU operation that includes retrieving BA frames from multiple STAs. A value of 3 indicates a multi-user request-to-send (MU-RTS) trigger frame, which may be used to enable RTS-CTS protection for MU operation. A value of 4 represents a Buffer Status Report Poll (BSRP) trigger frame variant, which may be used by an AP to query the amount of queued traffic at multiple STAs. A value of 5 denotes a groupcast with retries multi-user block acknowledgment request (GCR MU-BAR) trigger frame variant, which may be used by an AP to send MU BAR information to retrieve BA frames from STAs of a multicast group. A value of 6 represents a Bandwidth Query Report Poll (BQRP) trigger frame variant, which may be used by an AP to query STA's clear channel assessment (CCA) status. A value of 7 denotes a null data PPDU (NDP) Feedback Report Poll (NFRP) trigger frame variant, which may be used by an AP to query resource requests and approximate queue size from STAs using UL MU. The values 8-15 values are reserved for new trigger type variants.

As described above in FIGS. 24-25, a trigger frame according to embodiments may include a first indication associated with a first uplink resource allocation for a STA; a second indication associated with a second uplink resource allocation for the STA; and a third indication indicating whether an aggregated acknowledgment mode is enabled. FIG. 27 described below provide example trigger frame formats which may be used to implement embodiments of the present disclosure.

FIG. 27 illustrates an example 2700 of a trigger frame format according to an embodiment. Example trigger frame 2700 is provided for the purpose of illustration only and is not limiting of embodiments. Example trigger frame 2700 may be an embodiment of trigger frame 2408 described above in FIG. 24.

As shown in FIG. 27, Example trigger frame 2700 may be a modified version of a basic trigger frame as defined in the existing IEEE 802.11be standard amendment. Specifically, trigger frame 2700 may include a modified Common Info field 2702. Common Info field 2702 may include a Low Latency (LL) subfield in Bits 22, 26, 53, or 63. The LL subfield may thus replace a reserved bit of the Common Info field of the existing basic trigger frame.

In an embodiment, the LL subfield may carry the third indication whether an aggregated acknowledgment mode is enabled. In an embodiment, the LL subfield takes a value of 1 to indicate that the aggregated acknowledgment mode is enabled and a value of 0 to indicate that the aggregated acknowledgment mode is disabled.

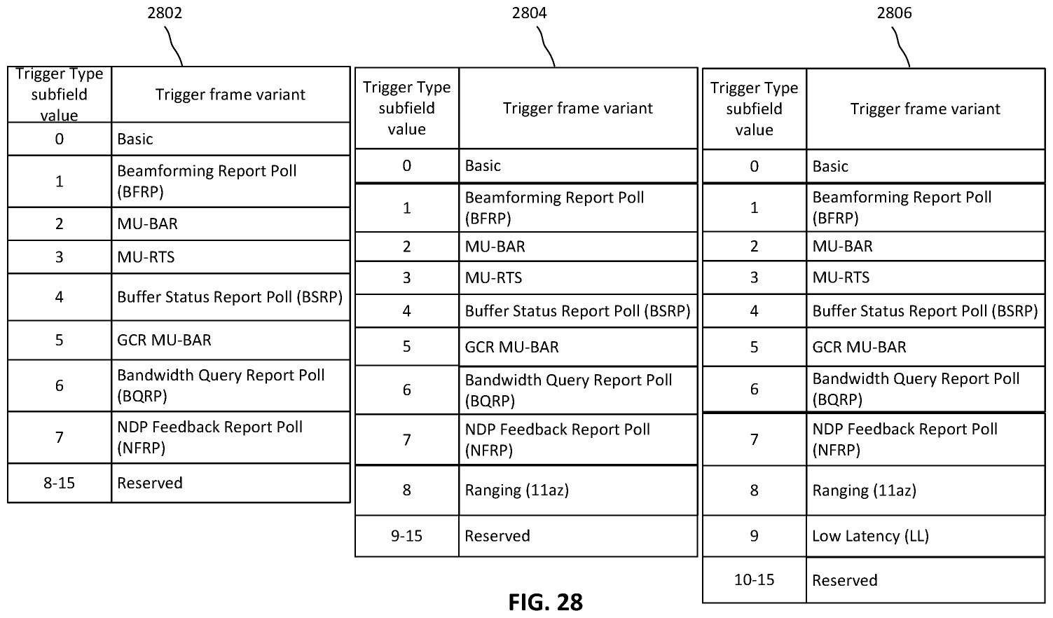

FIG. 28 illustrates an example Trigger Type subfield encoding 2806 according to an embodiment. For the purpose of illustration, FIG. 28 also shows a Trigger Type subfield encoding 2802 according to the IEEE 802.11 ax/be standard amendments and a Trigger Type subfield encoding 2804 according to the IEEE 802.11az standard amendment. Trigger Type subfield encoding 2902 is identical to the encoding described above with reference to FIG. 26. Trigger Type subfield encoding 2804 modifies encoding 2802 by using the previously reserved value of 8 of the Trigger Type subfield for ranging communication. Trigger Type subfield encoding 2806 further modifies encoding 2802 and/or 2804 by using the previously reserved value of 9 (or another reserved value) of the Trigger Type subfield to indicate a Low Latency (LL) trigger frame variant. In an embodiment, a STA receiving a trigger frame having a Trigger Type subfield with the value 9 identifies the trigger frame as an LL trigger frame variant. As such, the STA locates and reads the LL subfield from the Common Info field of the trigger frame to determine whether aggregated acknowledgment mode is enabled or disabled. The STA adapts its operation in accordance with this determination as described in the above embodiments.

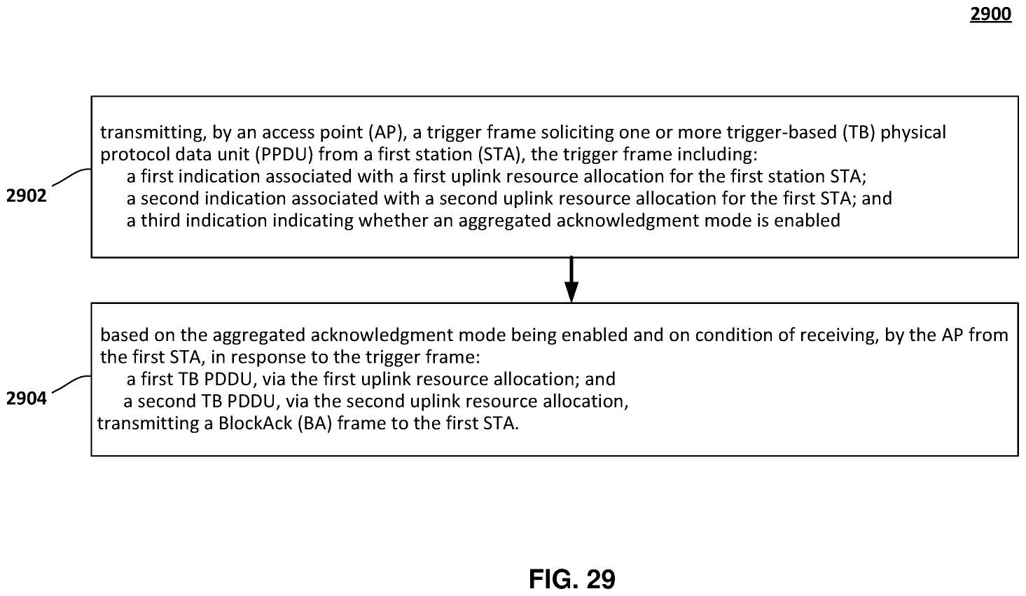

FIG. 29 illustrates an example process 2900 according to an embodiment. Example process 2900 is provided for the purpose of illustration only and is not limiting. Example process 2900 may be performed by an AP, such as AP 2402.

As shown in FIG. 29, process 2900 may begin in step 2902, which includes transmitting a trigger frame soliciting one or more TB PPDU from a first STA. The trigger frame may include: a first indication associated with a first uplink resource allocation for the first station STA; a second indication associated with a second uplink resource allocation for the first STA; and a third indication indicating whether an aggregated acknowledgment mode is enabled.

In an embodiment, the first uplink resource allocation and the second resource uplink allocation are associated with different time resources. In an embodiment, a first time resource associated with the first uplink resource allocation starts at a first time spacing from an end of transmission of the trigger frame. The first time spacing may be less than or equal to SIFS.

In an embodiment, the trigger frame comprises a Common Info field, and the third indication is provided in the Common Info field. In an embodiment, the third indication is provided in Bit 22, 26, 53 or 63 of the Common Info field. In an embodiment, the trigger frame may be a Basic trigger frame variant or a Low Latency trigger frame variant.

In step 2904, process 2900 may include, based on the aggregated acknowledgment mode being enabled and on the condition of receiving, by the AP from the first STA, in response to the trigger frame: a first TB PDDU via the first uplink resource allocation; and a second TB PDDU, via the second uplink resource allocation, transmitting a BA frame to the first STA. In an embodiment, the BA frame acknowledges the first TB PPDU and the second TB PPDU from the first STA.

In an embodiment, where the aggregated acknowledgment mode is enabled, process 2900 may further comprise reading an ACK policy indicator subfield of the second TB PPDU; and on condition of the ACK policy indicator subfield having a pre-determined value, transmitting the BA frame to the first STA. In an embodiment, the pre-determined value is equal to (00).

In an embodiment, an ACK policy indicator subfield of the first TB PPDU is set to a pre-determined value corresponding to no acknowledgment.

In an embodiment, the first TB PPDU is received a first time spacing after transmitting the trigger frame. In an embodiment, the first time spacing is less than or equal to a SIFS.

In an embodiment, receiving the second TB PPDU comprises receiving the second TB PPDU a second time spacing after receiving the first TB PPDU. In an embodiment, the second time spacing is less than or equal to a SIFS. In an embodiment, the second time spacing is equal to 0.

In an embodiment, transmitting the BA frame comprises transmitting the BA frame a third time spacing after receiving the second TB PPDU. In an embodiment, the third spacing is less than or equal to a SIFS.

In an embodiment, the trigger frame further includes a fourth indication associated with a third uplink resource allocation for a second STA. The third uplink resource allocation may be associated with a same time resource as the first uplink resource allocation or the second uplink resource allocation. In an embodiment, the third uplink resource allocation is associated with a same time resource as the first uplink resource allocation but with a different frequency resource or a different spatial resource than the first uplink resource allocation. In an embodiment, transmitting the BA frame comprises transmitting the BA on further condition of receiving, by the AP from the second STA, a third frame via the third uplink resource allocation. In an embodiment, the BA frame is a multi-STA BA frame.

In an embodiment, the first indication may indicate a first frequency resource and/or a first spatial resource associated with the first uplink resource allocation. In an embodiment, the second indication may indicate a second frequency resource and/or a second spatial resource associated with the second uplink resource allocation.

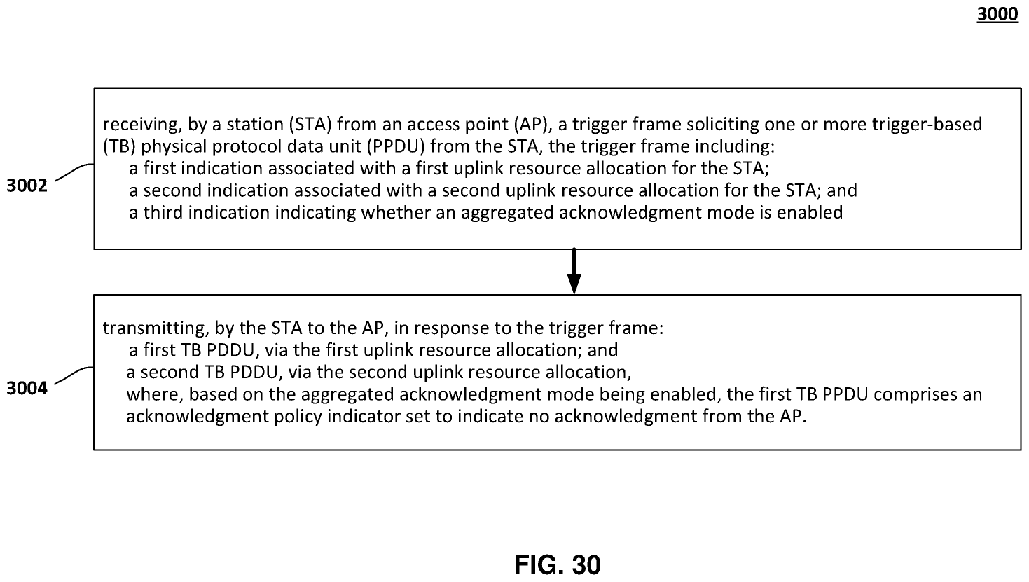

FIG. 30 illustrates an example process 3000 according to an embodiment. Example process 3000 is provided for the purpose of illustration only and is not limiting. Example process 3000 may be performed by a STA, such as such as STA 2404.

As shown in FIG. 30, process 3000 may begin in step 3002, which includes receiving, by a STA from an AP, a trigger frame soliciting one or more trigger-based (TB) physical protocol data unit (PPDU) from the STA, the trigger frame including: a first indication associated with a first uplink resource allocation for the STA; a second indication associated with a second uplink resource allocation for the STA; and a third indication indicating whether an aggregated acknowledgment mode is enabled.

In an embodiment, the first uplink resource allocation and the second resource uplink allocation are associated with different time resources. In an embodiment, a first time resource associated with the first uplink resource allocation starts at a first time spacing from an end of transmission of the trigger frame. The first time spacing may be less than or equal to SIFS. In an embodiment, a second time resource associated with the second uplink resource allocation starts at a second time spacing from an end of the first time resource. The second time spacing may be less than or equal to SIFS.

In an embodiment, the trigger frame comprises a Common Info field, and the third indication is provided in the Common Info field. In an embodiment, the third indication is provided in Bit 22, 26, 53 or 63 of the Common Info field. In an embodiment, the trigger frame may be a Basic trigger frame variant or a Low Latency trigger frame variant.

In step 3004, process 3000 may include transmitting, by the STA to the AP, in response to the trigger frame: a first TB PDDU, via the first uplink resource allocation; and a second TB PDDU, via the second uplink resource allocation. In an embodiment, based on the aggregated acknowledgment mode being enabled, the first TB PPDU comprises an acknowledgment policy indicator set to indicate no acknowledgment from the AP.

In an embodiment, transmitting the first TB PPDU comprises transmitting the first TB PPDU a first time spacing after receiving the trigger frame. In an embodiment, the first time spacing is less than or equal to a SIFS.

In an embodiment, transmitting the second TB PPDU comprises transmitting the second TB PPDU a second time spacing after transmitting the first TB PPDU. In an embodiment, the second time spacing is less than or equal to a SIFS. In an embodiment, the second time spacing is equal to 0.

In an embodiment, process 3000 may further comprise receiving, by the STA from the AP, a BA frame acknowledging the first TB PPDU and the second TB PPDU from the STA. In an embodiment, receiving the BA frame comprises receiving the BA frame a third time spacing after transmitting the second TB PPDU. In an embodiment, the third time spacing is less than or equal to a SIFS.

What is claimed is:

1. An access point (AP) comprising:
one or more processors; and
memory storing instructions that, when executed by the one or more processors, cause the AP to:
transmit a trigger frame soliciting one or more trigger-based (TB) physical protocol data unit (PPDU) from a first station (STA), the trigger frame comprising:
a first indication associated with a first uplink resource allocation for the first STA;
a second indication associated with a second uplink resource allocation for the first STA; and
a third indication indicating whether an aggregated acknowledgment mode is enabled; and
based on the aggregated acknowledgment mode being enabled and on condition of receiving, from the first STA and in response to the trigger frame, a first TB PPDU, via the first uplink resource allocation and a second TB PPDU, via the second uplink resource allocation, transmit, a BlockAck (BA) frame to the first STA.

2. The AP of claim 1, wherein the first uplink resource allocation and the second uplink resource allocation are associated with different time resources.

3. The AP of claim 1, wherein the BA frame acknowledges the first TB PPDU and the second TB PPDU from the first STA.

4. The AP of claim 1, wherein the trigger frame comprises a Common Info field, and wherein the third indication is provided in the Common Info field.

5. The AP of claim 1, wherein the aggregated acknowledgment mode is enabled, and wherein the instructions, when executed by the one or more processors, further cause the AP to:
read an ACK policy indicator subfield of the second TB PPDU; and
on condition of the ACK policy indicator subfield having a pre-determined value, transmit the BA frame to the first STA.

6. The AP of claim 1, wherein the trigger frame further comprises a fourth indication associated with a third uplink resource allocation for a second STA.

7. The AP of claim 6, wherein the third uplink resource allocation is associated with a same time resource as the first uplink resource allocation or the second uplink resource allocation.

8. The AP of claim 6, wherein the third uplink resource allocation is associated with a same time resource as the first uplink resource allocation but with a different frequency resource or a different spatial resource than the first uplink resource allocation.

9. The AP of claim 6, wherein the instructions, when executed by the one or more processors, further cause the AP to transmit the BA frame on further condition of receiving, from the second STA, a third frame via the third uplink resource allocation.

10. A station (STA) comprising:
one or more processors; and
memory storing instructions that, when executed by the one or more processors, cause the STA to:
receive, from an access point (AP), a trigger frame soliciting one or more trigger-based (TB) physical protocol data unit (PPDU) from the STA, the trigger frame including:
a first indication associated with a first uplink resource allocation for the STA;
a second indication associated with a second uplink resource allocation for the STA; and
a third indication indicating whether an aggregated acknowledgment mode is enabled;
transmit, to the AP, in response to the trigger frame:
a first TB PPDU, via the first uplink resource allocation; and
a second TB PPDU, via the second uplink resource allocation,
wherein, based on the aggregated acknowledgment mode being enabled, the first TB PPDU comprises an acknowledgment policy indicator set to indicate no acknowledgment from the AP.

11. The STA of claim 10, wherein the instructions, when executed by the one or more processors, further cause the STA to receive, from the AP, a BlockAck (BA) frame acknowledging the first TB PPDU and the second TB PPDU from the STA.

12. The STA of claim 10, wherein the first uplink resource allocation and the second resource uplink allocation are associated with different time resources.

13. The STA of claim 10, wherein the instructions, when executed by the one or more processors, further cause the STA to transmit the first TB PPDU a first time spacing after receiving the trigger frame.

14. The STA of claim 13, wherein the instructions, when executed by the one or more processors, further cause the STA to transmit the second TB PPDU a second time spacing after transmitting the first TB PPDU.

15. The STA of claim 14, wherein the second time spacing is less than or equal to a short interframe spacing (SIFS).

16. The STA of claim 10, wherein the trigger frame further includes a fourth indication associated with a third uplink resource allocation for a second STA.

17. The STA of claim 16, wherein the third uplink resource allocation is associated with a same time resource as the first uplink resource allocation or the second uplink resource allocation.

18. The STA of claim 16, wherein the third uplink resource allocation is associated with a same time resource as the first uplink resource allocation but with a different frequency resource or a different spatial resource than the first uplink resource allocation.

19. A non-transitory computer-readable medium comprising instructions that, when executed by one or more processors, cause an access point (AP) to:
transmit a trigger frame soliciting one or more trigger-based (TB) physical protocol data unit (PPDU) from a first station (STA), the trigger frame comprising:
a first indication associated with a first uplink resource allocation for the first STA;
a second indication associated with a second uplink resource allocation for the first STA; and
a third indication indicating whether an aggregated acknowledgment mode is enabled; and
based on the aggregated acknowledgment mode being enabled and on condition of receiving, from the first STA and in response to the trigger frame, a first TB PPDU, via the first uplink resource allocation and a second TB PPDU, via the second uplink resource allocation, transmit, a BlockAck (BA) frame to the first STA.

20. The non-transitory computer-readable medium of claim 19, wherein the BA frame acknowledges the first TB PPDU and the second TB PPDU from the first STA.
